(19) United States
(12) Patent Application Publication
(10) Pub. No.: US 2026/0289790 A1
(43) Pub. Date: Sep. 24, 2026

(54) INFORMATION PROCESSING APPARATUS, INFORMATION PROCESSING METHOD, AND PROGRAM

(71) Applicant: Sony Group Corporation, Tokyo (JP)

(72) Inventor: Guifen TIAN, Kanagawa (JP)

(73) Assignee: Sony Group Corporation, Tokyo (JP)

(21) Appl. No.: 19/473,403

(22) PCT Filed: Feb. 27, 2024
(86) PCT No.: PCT/JP2024/007154

§ 371 Date: Oct. 7, 2025

(30) Foreign Application Priority Data
Apr. 14, 2023 (JP) 2023-066427

(51) Int. Cl. G06T 7/12; G01S 17/89; G06T 7/136; G06V 10/77

(52) U.S. Cl. CPC G06T 7/12; G01S 17/89; G06T 7/136; G06V 10/7715; G06T 2207/20084; G06T 2207/30252

(57) ABSTRACT

There is provided an information processing apparatus to improve a processing speed while ensuring accuracy of semantic segmentation, and further reduce a memory consumption amount. The information processing apparatus includes: a first processing unit configured to perform first segmentation on an input image, and output a result of the first segmentation and a reliability related to the result of the first segmentation; a second processing unit configured to perform second segmentation having higher accuracy than accuracy of the first segmentation on an image region in which a reliability related to a result of the first segmentation is lower than a threshold value, the second processing unit being configured to output a result of the second segmentation; and an estimation unit configured to output an estimation result based on a result of the first segmentation and a result of the second segmentation, in which the input image includes an image acquired by LiDAR.

### TECHNICAL FIELD

The present technology relates to an information processing apparatus, an information processing method, and a program.

### BACKGROUND ART

It is known that a plurality of cameras is mounted on a vehicle to obtain information around the vehicle, in order to improve safety during driving and the like of the vehicle. For example, Patent Document 1 describes detection of an object accompanied by movement, by performing recognition processing using an image obtained by a camera mounted on a vehicle.

### CITATION LIST

### Patent Document

Patent Document 1: Japanese Patent Application Laid-Open No. 2012-123470

### SUMMARY OF THE INVENTION

### Problems to be Solved by the Invention

In order to recognize an overall periphery of the vehicle with high accuracy, if similar recognition processing is always performed on images individually acquired by a plurality of cameras mounted on the vehicle, there has been a problem that an overall arithmetic amount increases.

As described above, in a field of recognition processing, there is a demand for a technology capable of reducing the arithmetic amount without deteriorating recognition accuracy.

In view of the above circumstances, an object of the present technology is to provide an information processing apparatus, an information processing method, and a program capable of reducing the arithmetic amount without deteriorating recognition accuracy.

### Solutions to Problems

According to an aspect of the present disclosure, there is provided an information processing apparatus including: a first processing unit configured to perform first segmentation on an input image, and output a result of the first segmentation and a reliability related to the result of the first segmentation; a second processing unit configured to perform second segmentation having higher accuracy than accuracy of the first segmentation on an image region in which a reliability related to a result of the first segmentation is lower than a threshold value, the second processing unit being configured to output a result of the second segmentation; and an estimation unit configured to output an estimation result based on a result of the first segmentation and a result of the second segmentation, in which the input image includes an image acquired by LiDAR.

Furthermore, according to another aspect of the present disclosure, there is provided an information processing method performed by a processor, the information processing method including: performing first segmentation on an input image, and outputting a result of the first segmentation and a reliability related to the result of the first segmentation; performing second segmentation having higher accuracy than accuracy of the first segmentation on an image region in which a reliability related to a result of the first segmentation is lower than a threshold value, and outputting a result of the second segmentation; and outputting an estimation result based on a result of the first segmentation and a result of the second segmentation, in which the input image includes an image acquired by LiDAR.

Furthermore, according to another aspect of the present disclosure, there is provided a program for causing a computer to function as an information processing apparatus including: a first processing unit configured to perform first segmentation on an input image, and output a result of the first segmentation and a reliability related to the result of the first segmentation; a second processing unit configured to perform second segmentation having higher accuracy than accuracy of the first segmentation on an image region in which a reliability related to a result of the first segmentation is lower than a threshold value, the second processing unit being configured to output a result of the second segmentation; and an estimation unit configured to output an estimation result based on a result of the first segmentation and a result of the second segmentation, in which the input image includes an image acquired by LiDAR.

### BRIEF DESCRIPTION OF DRAWINGS

FIG. 1 is a schematic diagram illustrating a configuration example of a processing unit of an information processing apparatus according to each embodiment of the present technology.

FIG. 2 is a flowchart illustrating an image recognition processing method (information processing method) in the processing unit described above.

FIG. 3 is a top view of a vehicle, and is a view illustrating an example of a mounting position of a sensor unit.

FIG. 4 is a schematic diagram illustrating a configuration example of an information processing system according to a second embodiment.

FIG. 5 is a flowchart illustrating an image recognition processing method (information processing method) according to the second and third embodiments.

FIG. 6 is a schematic diagram for describing a neural network for feature extraction.

FIG. 7 is a schematic diagram for describing a neural network for semantic segmentation.

FIG. 8 is a schematic diagram for describing a neural network for instance segmentation (object detection).

FIG. 9 is a schematic diagram for describing a neural network for optical flow (motion detection).

FIG. 10 is a schematic diagram for describing a neural network for distance detection.

FIG. 11 is a flowchart illustrating an image recognition processing method (information processing method) according to each embodiment.

FIG. 12 is a flowchart illustrating details of second task determination processing in step 4 of the flowchart of FIG. 11.

FIG. 13 is a diagram for describing a specific example of the second task determination processing.

FIG. 14 is a flowchart illustrating details of parameter generation processing in step 5 of the flowchart of FIG. 11.

FIG. 15 is a table for describing a specific example of parameter generation.

FIG. 16 is a diagram for describing a specific example of parameter generation.

FIG. 17 is a table for describing a specific example of parameter generation.

FIG. 18 is a table for describing a configuration example of a neural network.

FIG. 19 is a diagram for describing that an arithmetic amount on a decoder side can be reduced by a reconfigured neural network, using distance detection as an example.

FIG. 20 is a schematic diagram illustrating a configuration example of an information processing system according to the third embodiment.

FIG. 21 is a diagram for describing an input image according to a fourth embodiment.

FIG. 22 is a diagram for describing first segmentation and second segmentation according to the fourth embodiment.

FIG. 23 is a table for describing a performance example of a first model M1 and a second model M2 according to the fourth embodiment.

FIG. 24 is a block diagram illustrating a functional configuration example of a first task estimation unit 32 according to the fourth embodiment.

FIG. 25 is a flowchart illustrating a flow of processing in a case where at least an RGB image is used as an input image according to the fourth embodiment.

FIG. 26 is a flowchart illustrating a flow of processing in a case where only an ambient image is used as an input image, according to the fourth embodiment.

FIG. 27 is a flowchart illustrating a flow of processing in a case where both an RGB image and an ambient image are used as an input image, according to the fourth embodiment.

FIG. 28 is a diagram for describing a determination example of whether or not to execute processing of a second task in a case where the above-described semantic segmentation is performed on an ambient image, according to the fourth embodiment.

FIG. 29 is a block diagram illustrating a hardware configuration example of an information processing apparatus 90 according to an embodiment.

### MODE FOR CARRYING OUT THE INVENTION

Preferred embodiments of the present disclosure will be described below in detail, with reference to the accompanying drawings. Note that, in the present specification and drawings, components having substantially the same functional configuration are denoted by the same reference signs, and repetitive explanations are not made.

Furthermore, in the present specification and the drawings, in a case where a plurality of configurations of the same type is distinguished and described, an alphabet or the like may be added to the end of the reference numeral. Whereas, in a case where it is not necessary to distinguish a plurality of configurations of the same type, the alphabet or the like described above may be omitted, and a description common to all of the plurality of configurations of the same type may be made.

Note that, the description will be given in the following order.
1. Embodiment
1.1. Introduction
1.2. First Embodiment
1.3. Second Embodiment
1.4. Third Embodiment
1.5. Fourth Embodiment
2. Hardware Configuration Example
3. Conclusion

### 1. EMBODIMENT

### 1.1. Introduction

In the present technology, in recognition processing on a recognition target by an information processing apparatus capable of processing a plurality of different tasks having common feature extraction for the recognition target, on the basis of a recognition result obtained by one task, whether or not to execute remaining other tasks is determined. With such a configuration, an arithmetic amount can be reduced without deteriorating recognition accuracy.

In the following description, an example in which the recognition target is an image (camera image) will be described. In first to third embodiments to be described later, an example will be described in which the present technology is applied to recognition processing on an image acquired by an imaging unit mounted on a four-wheeled automobile (hereinafter, may be simply referred to as a “vehicle”) as a mobile body. The image includes peripheral information (outside-vehicle information) of the vehicle, and a traveling scene (moving scene) of the vehicle can be estimated from the image.

In the first embodiment, a characteristic configuration of the present technology will be mainly described. In the first embodiment, an outline of image recognition processing performed on one image (hereinafter, may be referred to as an input image) will be described.

In the second and third embodiments, with a case as an example in which a plurality of imaging units is mounted on a vehicle and senses an overall periphery of the vehicle, an example will be described in which the present technology is applied to recognition processing on an image acquired by each of the plurality of imaging units. Image recognition processing to which the present technology is applied will be described more specifically in the second embodiment.

Note that the image recognition processing in information processing apparatuses according to the first, second, and third embodiments is the same. In the second embodiment, an example will be described in which driving assistance is provided to a driver who is an operator of the vehicle, on the basis of an image recognition processing result. In the third embodiment, with an example in which the vehicle is automatedly movable, an example will be described in which a travel route plan of the vehicle and an action plan of the vehicle are given on the basis of an image recognition processing result. The automated movement is so-called automated driving in which the vehicle automatedly moves without depending on an operation of the driver.

Typically, in a vehicle, manual driving and automated driving can be switched by the driver. “Driving” is “movement of a mobile body”.

Note that both the driving assistance described in the second embodiment and the automated driving control described in the third embodiment may be possible in a configuration.

In the following description, “right” and “left” refer to “right” and “left” as viewed from the driver in the vehicle, “front” indicates a traveling direction of the vehicle, and “rear” indicates a direction opposite to the traveling direction.

### 1.2. First Embodiment

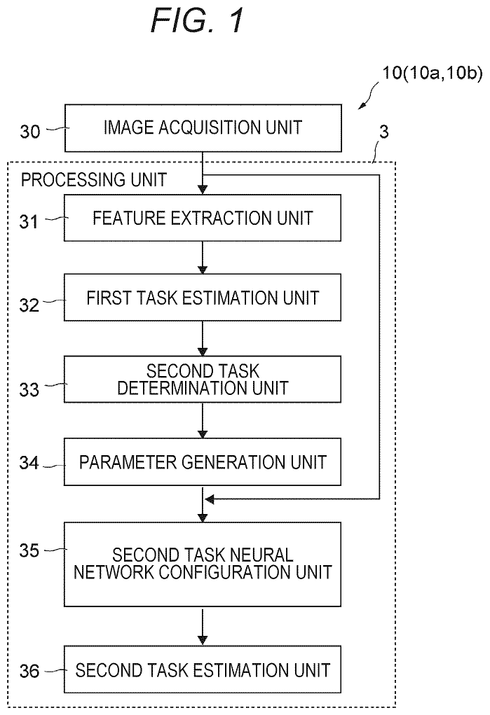

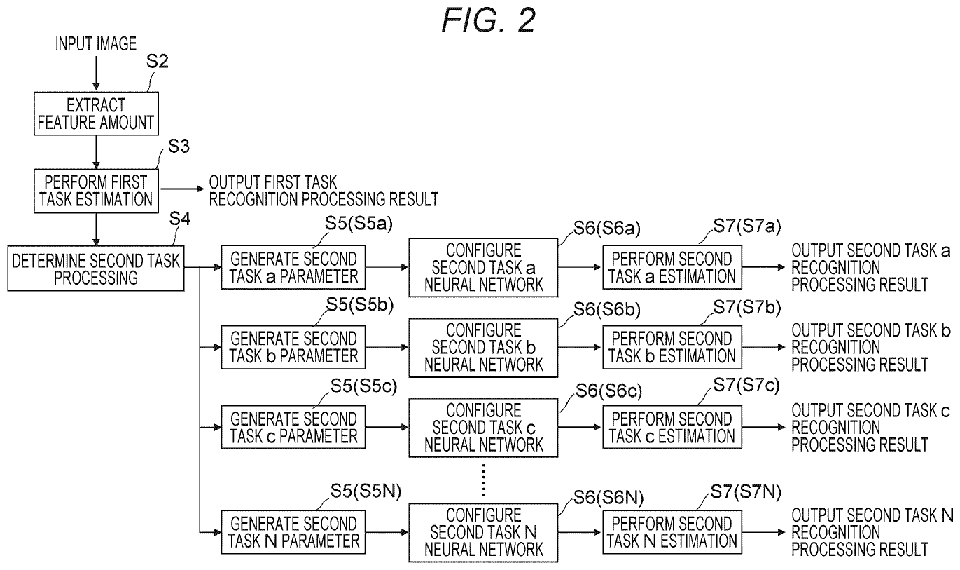

FIG. 1 is a schematic diagram illustrating a configuration example of a processing unit 3 of an information processing apparatus 10 according to the first embodiment. FIG. 2 is a flowchart illustrating an example of an image processing method (information processing method) in the processing unit 3. Note that a processing unit 3 of an information processing apparatus 10a according to the second embodiment and a processing unit 3 of an information processing apparatus 10b according to the third embodiment described later have a configuration similar to that of the processing unit 3 of the information processing apparatus 10.

### [Information Processing Apparatus]

The information processing apparatus 10 can execute a plurality of tasks related to the image recognition processing on one image. The image is a recognition target and is acquired by an imaging unit mounted on the vehicle. Hereinafter, the image as the recognition target may be referred to as an “input image”. The information processing apparatus 10 of the present embodiment can simultaneously process a plurality of tasks having common feature extraction for one input image. That is, the information processing apparatus 10 can perform a plurality of different types of task processing by using a plurality of feature amounts extracted by the same feature extractor. Hereinafter, the feature extractor is denoted by reference numeral 37. Details will be described in the second embodiment.

Note that, in FIG. 2, the number of tasks is N.

In the present embodiment and the second and third embodiments described later, examples of processing four tasks will be described as recognition tasks, including classification by semantic segmentation, object detection by instance segmentation, motion detection by optical flow, and distance detection.

A plurality of tasks (four in the present embodiment) that can be executed by the information processing apparatus 10 is classified into a first task and a second task. The first task and the second task are recognition tasks, and more specifically, are image recognition tasks in the present embodiment. The image recognition task can be executed on an image acquired by an imaging unit mounted on a vehicle, and driving assistance presentation, automated driving control, and the like can be performed using a recognition processing result.

The semantic segmentation (classification) is the first task. The instance segmentation (object detection), the optical flow (motion detection), and the distance detection are the second tasks.

The semantic segmentation as the first task is classification. In the semantic segmentation, each pixel of an input image is classified into an object class (category) the pixel belongs.

The instance segmentation as the second task is object detection (also referred to as instance detection). In the instance segmentation, an object in an input image is detected. In the following description, it is mainly referred to as “object detection”.

The optical flow as the second task is motion detection. In the optical flow, movement of an object in an input image is detected. Specifically, in the optical flow, movement of an attention object between two temporally consecutive input image frames is estimated. In the following description, it is mainly referred to as “motion detection”.

In the distance detection as the second task, a distance between an object and the vehicle (vehicle on which the imaging unit is mounted) is estimated using a feature amount extracted by the feature extractor 37 and a LiDAR point group acquired by light detection and ranging (LiDAR) as a distance measurement unit (described later). The LiDAR is a technology of emitting infrared laser light and sensing a distance and a position of a person or an object around, from reflection of the infrared laser light. The LiDAR in the present disclosure can also be said as a distance measurement sensor that is mounted on the vehicle, senses an environment, and performs obstacle detection and the like.

Details of each task processing will be described in the second embodiment to be described later.

In the image recognition processing by the processing unit 3 of the information processing apparatus 10, on the basis of a recognition result obtained by the semantic segmentation (first task), determination is made as to whether or not to execute each of the object detection (instance segmentation), the motion detection (optical flow), and the distance detection, which are remaining other tasks (second tasks). With such a configuration, the arithmetic amount can be reduced. A specific example will be described in the second embodiment.

As illustrated in FIG. 1, the information processing apparatus 10 includes an image acquisition unit 30 and the processing unit 3. The processing unit 3 has a feature extraction unit 31, a first task estimation unit 32, a second task determination unit 33, a parameter generation unit 34, a second task neural network configuration unit 35, and a second task estimation unit 36.

The image acquisition unit 30 acquires an image (input image) acquired by the imaging unit.

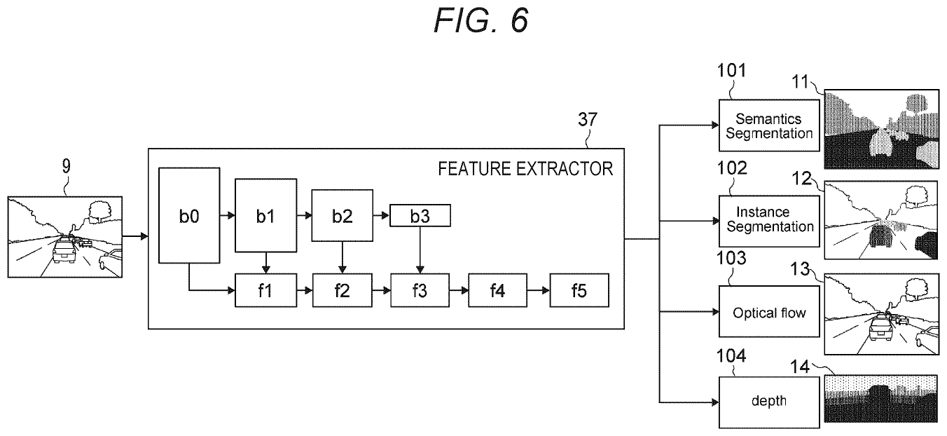

The feature extraction unit 31 extracts a plurality of feature amounts common to a plurality of tasks (the first task and the second task) from the input image. The feature extraction unit 31 includes the feature extractor 37 (see, for example, FIG. 6 and the like).

The first task estimation unit 32 performs semantic segmentation on the input image by using deep learning, and performs classification on a pixel basis.

From a semantic segmentation result (recognition result of the first task processing on the input image), a scene feature of the input image can be estimated. For example, a driving scene feature (moving scene feature) is obtained from the semantic segmentation result. Hereinafter, the “driving scene feature” is simply referred to as a “scene feature”.

The scene feature indicates whether or not there is an object that hinders driving and whether or not the object is a movable object. Hereinafter, the “object that hinders driving” may be referred to as an “attention object”.

The objects that hinder driving include, for example, vehicles such as a four-wheeled automobile, a two-wheeled automobile, a bicycle, and a train, a utility pole, a traffic signal, a trash bin, a pole, a person, and an animal. Whereas, objects that do not hinder driving include, for example, a road surface, the sky, or the like.

The objects that hinder driving can be further classified into a movable object and an immovable object (so-called a stationary body). The movable objects include, for example, a vehicle, a person, an animal, and the like.

The second task determination unit 33 determines whether or not to execute each of the object detection, the motion detection, and the distance detection, which are the second tasks, on the basis of the semantic segmentation result. On the basis of the scene feature obtained from the semantic segmentation result, the second task determination unit 33 determines the second task to be executed in order to obtain an image recognition processing result necessary for acquiring information necessary for automated driving, driving assistance, and the like.

In a case where there is no attention object (object that hinders driving) in the input image, the second task determination unit 33 determines not to execute the object detection and the motion detection but to execute only the distance detection.

In a case where there is an attention object in the input image but there is no movable object, the second task determination unit 33 determines not to execute the motion detection but to execute only the object detection and the distance detection.

In a case where there is a movable attention object, the second task determination unit 33 determines to execute all the second tasks of the object detection, the motion detection, and the distance detection.

As described above, since the second task (image recognition task) to be executed is determined so as to obtain a necessary image recognition processing result in accordance with the scene feature obtained from the semantic segmentation result, the arithmetic amount of the recognition processing can be reduced without deteriorating recognition accuracy.

The parameter generation unit 34 dynamically generates a parameter for the second task determined to be executed, by using the semantic segmentation result. Examples of the parameter for the second task include a processing target image on which the second task is executed and a feature amount to be used when the second task is executed. The processing target image is a minimum rectangular image region including the attention object (described later). The feature amount to be used when the second task is executed is determined according to the number of pixels of the attention object.

From the semantic segmentation result, a category of the attention object and an image region where the attention object is present can be grasped.

In the object detection, the parameter generation unit 34 uses the semantic segmentation result to generate an object detection parameter so as to process a partial neural network corresponding to the object category and the number of pixels of the image region in which the attention object is present.

In the distance detection, in a case where there is an attention object, the parameter generation unit 34 generates a distance detection parameter so as to process only an image region (processing target image) including the attention object and process a partial neural network according to the number of pixels of the attention object.

Whereas, in the distance detection, in a case where there is no attention object, the parameter generation unit 34 generates a distance detection parameter so as to process the entire input image and use all the feature amounts.

In the motion detection, in a case where there is a movable attention object, the parameter generation unit 34 generates a motion detection parameter so as to process only an image region (processing target image) including the movable attention object and to process a partial neural network according to the number of pixels of the attention object.

By using the parameter generated by the parameter generation unit 34, the second task neural network configuration unit 35 configures respective neural networks for the object detection, the motion detection, and the distance detection, which are the second tasks.

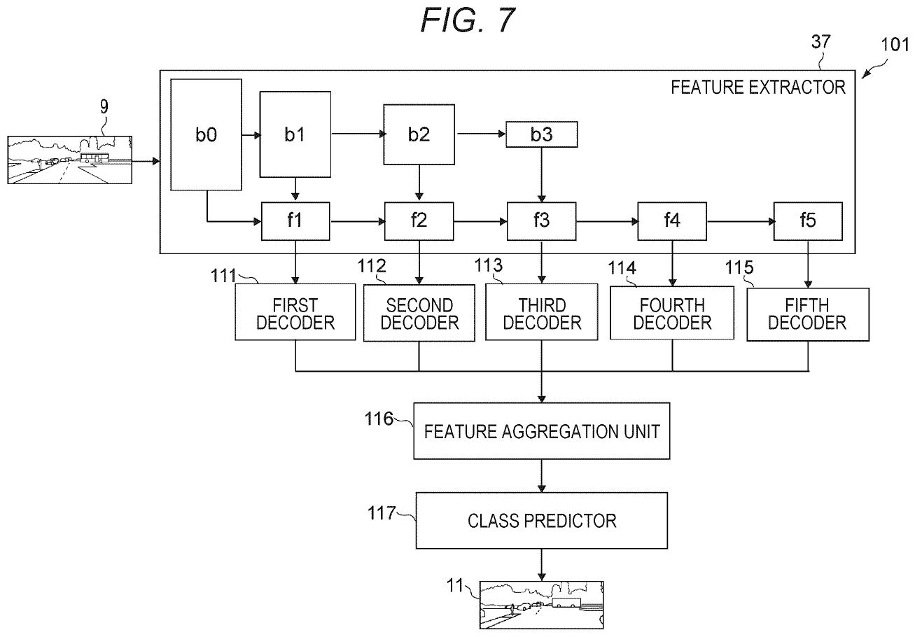

Furthermore, in a case where all feature amounts f1 to f5 are generated as the parameters by the parameter generation unit 34, the second task neural network configuration unit 35 sets a standard neural network as a neural network to be used for the second task processing. In the embodiment, the “standard neural network” refers to a neural network configured to use all the feature amounts f1 to f5 illustrated in FIGS. 7 to 9 described later.

The second task estimation unit 36 executes the object detection (instance segmentation) by using the configured object detection neural network.

The second task estimation unit 36 executes the distance detection to estimate a distance by using the configured distance detection neural network.

The second task estimation unit 36 executes the motion detection (optical flow) to estimate a motion of the object by using the configured motion detection neural network.

The information processing apparatus 10 has a hardware configuration necessary for a computer, such as, for example, a central processing unit (CPU), a memory (RAM, ROM), and the like. In the information processing apparatus 10, the CPU loads a program stored in a storage unit (not illustrated) into the RAM and executes the program, thereby executing various types of processing. The storage unit stores a program for executing the image recognition processing according to the present embodiment.

### [Information Processing Method (Image Recognition Processing Method)]

With reference to FIG. 2, an information processing method (image recognition processing method) performed by the processing unit 3 of the information processing apparatus 10 of the present embodiment will be described. In FIG. 2, a plurality of mutually different second tasks is indicated as a second task a, a second task b, a second task c . . . and a second task N. N corresponds to the number of the second tasks. For example, in FIG. 2, it is assumed that the second task a indicates the object detection (instance segmentation), the second task b indicates the motion detection (optical flow), and the second task c indicates the distance detection. Note that the number of second tasks is not particularly limited, and is only required to be one or more.

As illustrated in FIG. 2, when an image is input to the processing unit 3, the feature extraction unit 31 extracts a plurality of feature amounts of the input image (S2).

Next, the first task estimation unit 32 executes the first task (semantic segmentation in the present embodiment) using the plurality of feature amounts extracted in S2 (S3). A semantic segmentation result (first task processing result) is output to the second task determination unit 33. The semantic segmentation result can be used to estimate a scene feature of the input image.

Next, the second task determination unit 33 determines whether or not to execute each of the second tasks a, b, and c to N by using the semantic segmentation result (S4). In the present embodiment, the second task determination unit 33 determines whether or not to execute each of the object detection, the motion detection, and the distance detection. In a case where there is another second task, whether or not to execute the second task is also determined.

Next, the parameter generation unit 34 generates a parameter for the second task (S5).

In FIG. 2, a parameter generation step of generating a parameter for the second task a (object detection) is represented as S5a. A parameter generation step of generating a parameter for the second task b (motion detection) is represented as S5b. A parameter generation step of generating a parameter for the second task c (distance detection) is represented as S5c. A parameter generation step of generating a parameter for the second task N is represented as S5N. In a case where it is not necessary to distinguish these S5a, S5b, S5c, . . . , and S5N, S5 is used.

In the present embodiment, as illustrated in FIG. 2, the parameter for the second task a is generated using the semantic segmentation result (S5a). The parameter for the second task b is generated using the semantic segmentation result (S5b). The parameter for the second task c is generated by using the semantic segmentation result (S5c). The parameter for the second task N is generated using the semantic segmentation result (S5N).

Next, the second task neural network configuration unit 35 configures a neural network of the second task by using the parameter generated in S5 (S6).

The neural network configured here is the standard neural network or a neural network reconfigured to use only some feature amounts.

In FIG. 2, a step of configuring a neural network of the second task a is represented as S6a. A step of configuring a neural network of the second task b is represented as S6b. A step of configuring a neural network of the second task c is represented as S6c. A step of configuring a neural network of the second task N is represented as S6N. In a case where it is not necessary to distinguish these S6a, S6b, S6c, . . . , and S6N, S6 is used.

In the present embodiment, as illustrated in FIG. 2, the neural network of the second task a is configured using the parameter generated in S5a (S6a). The neural network of the second task b is configured using the parameter generated in S5b (S6b). The neural network of the second task c is configured using the parameter generated in S5c (S6c). The neural network of the second task b is configured using the parameter generated in S5N (S6N).

Next, the second task estimation unit 36 executes the second task using the neural network configured in S6 (S7).

In FIG. 2, an estimation step using the configured neural network of the second task a is represented as S7a. An estimation step using the configured neural network of the second task b is represented as S7b. An estimation step using the configured neural network of the second task c is represented as S7c. An estimation step using the configured neural network of the second task N is represented as S7N. In a case where it is not necessary to distinguish these S7a, S7b, S7c, . . . , and S7N, S7 is used.

In the present embodiment, as illustrated in FIG. 2, the instance segmentation is executed using the configured neural network of the second task a (object detection) (S7a), and an object detection result (recognition processing result of the second task a) is output.

The optical flow is executed using the configured neural network of the second task b (motion detection) (S7b), and a motion detection result (recognition processing result of the second task b) is output.

The distance detection is executed using the configured neural network of the second task c (distance detection) (S7c), and a distance detection result (recognition processing result of the second task c) is output.

By using the output recognition processing result (the semantic segmentation result, the object detection result, the motion detection result, the distance detection result), it is possible to increase accuracy of driving assistance (details will be described in the second embodiment) and automated driving (details will be described in the third embodiment) while reducing power consumption.

In the present embodiment and the second and third embodiments to be described later, an example will be described in which the processing unit executes four types of task processing. However, the number of tasks is not limited to four, and is only required to be two or more, and it suffices that one first task and one or more second tasks are included.

A processing result of the first task is used to determine whether or not to execute other second tasks. The first task is an essential task for determining whether or not to execute other second tasks. In the image recognition processing, the semantic segmentation is typically used as the first task.

The number of the second tasks is only required to be one or more. Whether or not to execute the second task is determined on the basis of a processing result of the first task. In the image processing using the present technology, as the second task, one or more tasks selected from object detection (instance segmentation), motion detection (optical flow), distance detection, normal estimation, pose estimation, trajectory estimation, and the like can be used.

In the first to third embodiments, three tasks of the object detection (instance segmentation), the motion detection (optical flow), and the distance detection are exemplified as the second tasks.

As described above, in the present technology, the second task to be executed is determined according to a semantic segmentation result (recognition result of the first task processing on the recognition target), and further, a parameter for the second task is generated. Then, a neural network of the second task is configured using the generated parameter, and the image recognition task is performed using the configured neural network.

In the present technology, since the second task to be executed is determined using the semantic segmentation result, only the recognition task necessary for image recognition can be executed, and the arithmetic amount of the entire recognition processing can be reduced without deteriorating recognition accuracy.

Moreover, in the present technology, since the neural network is configured using the parameter generated using the semantic segmentation result, it is possible to process only a partial network according to a scene feature, and it is possible to reduce the arithmetic amount of the recognition processing while maintaining higher recognition accuracy.

As a result, power consumption can be reduced, a processing delay is suppressed, and a real-time recognition processing result with high recognition accuracy can be obtained. Then, by using such a recognition processing result, it is possible to perform highly accurate driving assistance and automated driving control at an appropriate timing.

Furthermore, the present technology is very effective in reducing an arithmetic amount in a system that performs image recognition processing on each of a plurality of images in real time as in the second and third embodiments to be described later.

For example, in an entire peripheral sensing system in which a plurality of imaging units is mounted on a vehicle and peripheral information of the vehicle is acquired in a wide range, if four recognition tasks are always executed for each image acquired by each imaging unit, the arithmetic amount becomes enormous. However, by applying the image recognition processing method (information processing method) of the present technology to each image acquired by each imaging unit, it is possible to reduce the arithmetic amount of the entire recognition processing while maintaining high recognition accuracy. As a result, in a mode in which each of a plurality of images needs to be subjected to image recognition processing in real time as in the entire peripheral sensing system, power consumption can be reduced, a processing delay is suppressed, and highly accurate driving assistance and automated driving control can be performed at an appropriate timing.

### 1.3. Second Embodiment

In the second embodiment, an example will be described in which the technology described in the first embodiment is applied to image recognition processing on each image acquired by each of a plurality of imaging units mounted on a vehicle, and an image recognition processing result is used for driving assistance.

### [Example of Vehicle]

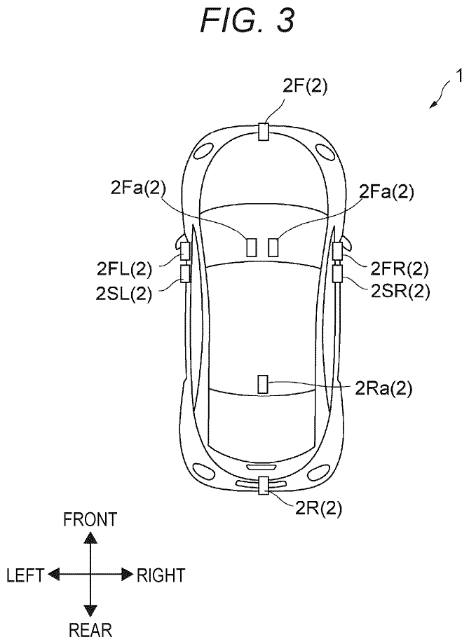

FIG. 3 is a top view of a vehicle, and illustrates position examples of a plurality of sensor units 2 mounted on the vehicle. Although details will be described later, each sensor unit 2 includes an imaging unit 20 and a distance measurement unit 21. Note that positions of the sensor unit 2 illustrated in FIG. 3 are an example, and are not limited thereto. Furthermore, in a case where it is not necessary to distinguish the plurality of sensor units 2 to be described, the plurality of sensor units 2 is referred to as a sensor unit 2.

As illustrated in FIG. 3, for example, a vehicle 1 is mounted with a front sensor unit 2F, two front sensor units 2Fa, a right front sensor unit 2FR, a left front sensor unit 2FL, a right side sensor unit 2SR, a left side sensor unit 2SL, a rear sensor unit 2R, and a rear sensor unit 2Ra. All of the sensor units 2 can acquire peripheral information of the vehicle.

The front sensor unit 2F is disposed near a front bumper, and acquires peripheral information in front of the vehicle.

The two front sensor units 2Fa are disposed at the front of a roof, and acquire vehicle peripheral information in front of the vehicle.

The right front sensor unit 2FR is disposed forward of a right side portion of the vehicle, and acquires vehicle peripheral information on the diagonally right front of the vehicle.

The left front sensor unit 2FL is disposed forward of a left side portion of the vehicle, and acquires vehicle peripheral information on the diagonally left front of the vehicle.

The right side sensor unit 2SR is disposed behind the right front sensor unit 2FR, and acquires vehicle peripheral information on the right of the vehicle.

The left side sensor unit 2SL is disposed behind the left front sensor unit 2FL, and acquires vehicle peripheral information on the left of the vehicle.

The rear sensor unit 2R is disposed near a rear bumper, and acquires vehicle peripheral information behind the vehicle.

The rear sensor unit 2Ra is disposed at the rear of the roof, and acquires vehicle peripheral information behind the vehicle.

In the second and third embodiments, for the sake of convenience, an example will be described in which the present technology is applied to recognition processing of sensing results (images) in the imaging unit 20 of the respective five sensor units of the front sensor unit 2F, the right front sensor unit 2FR, the left front sensor unit 2FL, the right side sensor unit 2SR, and the left side sensor unit 2SL. Note that the number of the sensor units 2 to which the present technology is applied is not limited to this, and is only required to be one or more.

### [Information Processing System]

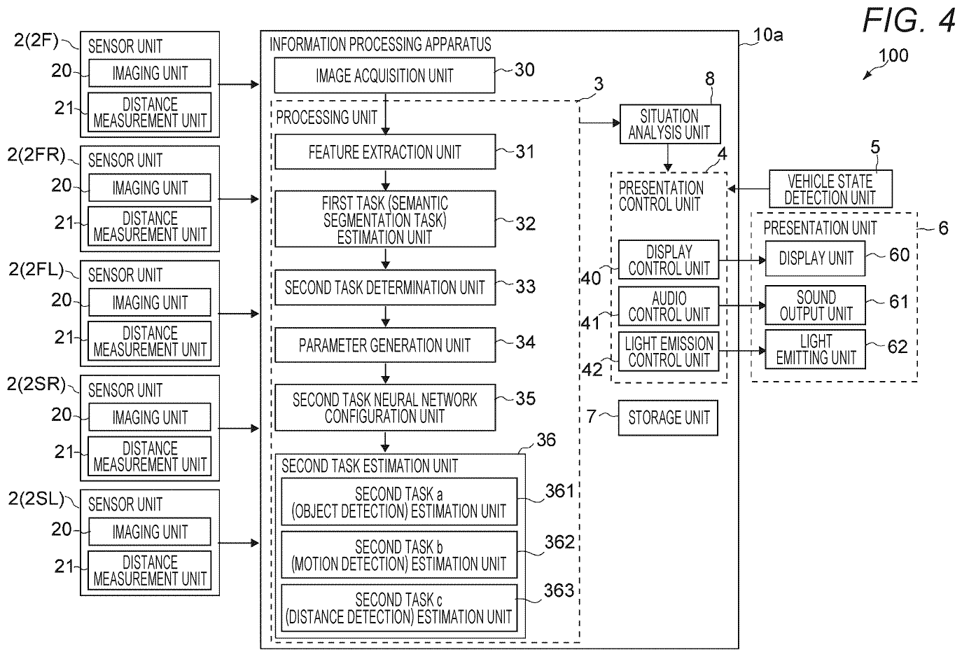

FIG. 4 is a schematic configuration diagram of an information processing system 100 according to the present embodiment. In the information processing system 100, driving assistance processing using recognition processing results of acquired images of a plurality of imaging units 20 mounted on the vehicle 1 is performed. The information processing system 100 of the present embodiment can be rephrased as a driving assistance system.

As illustrated in FIG. 4, the information processing system 100 includes the plurality of sensor units 2, the information processing apparatus 10a, a vehicle state detection unit 5, and a presentation unit 6. These are all mounted on the vehicle 1.

### (Sensor Unit)

Each sensor unit 2 includes the imaging unit 20 and the distance measurement unit 21.

The imaging unit 20 acquires an image, and includes, for example, a CMOS sensor. The imaging unit 20 of the present embodiment acquires an image around the vehicle 1. As the imaging unit 20, a monocular camera, a stereo camera, or the like can be used.

The distance measurement unit 21 is configured to be able to measure a distance between the vehicle 1 on which the imaging unit 20 is mounted and an object around the vehicle 1. For the distance measurement unit 21, LiDAR, a stereo camera, a millimeter wave radar, or the like can be used, and the distance measurement unit 21 includes one or more selected from these. In the present embodiment, an example in which LiDAR is used as the distance measurement unit 21 will be described.

An image acquired by the imaging unit 20 of the sensor unit 2 and three-dimensional point group information acquired by the LiDAR as the distance measurement unit 21 are output to the information processing apparatus 10a.

Note that, in each sensor unit 2, typically, the imaging unit 20 and the distance measurement unit 21 are disposed close to each other. In general, since installation positions of a camera (imaging unit) and LiDAR (distance measurement unit) are different, correspondence information between a camera coordinate system having a camera position as an origin and a LiDAR coordinate system having a LiDAR position as an origin is acquired in advance and stored. Using this correspondence information, it is possible to perform the image recognition processing related to distance detection by associating an image acquired by the camera with a three-dimensional point group acquired by LiDAR.

### (Presentation Unit)

The presentation unit 6 includes a device capable of outputting and presenting visual information or auditory information to a driver of the vehicle 1. The presentation unit 6 is mounted on the vehicle 1. The presentation unit 6 can present, to the driver of the vehicle 1, information related to driving assistance, such as notification of vehicle peripheral information and suggestion of a preferable speed and a traveling route for prompting attention and warning.

The presentation unit 6 includes, for example, a display unit 60, a sound output unit 61, and a light emitting unit 62. The driving assistance may be performed using one or more selected from the display unit 60, the sound output unit 61, and the light emitting unit 62. Driving assistance information is visually presented to the driver by display on the display unit 60 or lighting or blinking of the light emitting unit 62. The driving assistance information is presented audibly to the driver by audio output from the sound output unit 61.

The visual or auditory presentation of the driving assistance information to the driver by the presentation unit 6 is performed using an image recognition processing result in the processing unit 3 on an image acquired by the sensor unit 2.

The driving assistance information is effective information for preventing an accident or the like in advance during driving of the vehicle, for example. Examples of the driving assistance include an obstacle warning, a collision warning of the own vehicle, a lane deviation warning of the own vehicle, a driving operation command, a speed change command, a vehicle overtaking recommendation, a lane change recommendation, notification of traveling condition information, and the like. The driver can drive more safely on the basis of the driving assistance information presented from the presentation unit 6.

The display unit 60 displays visual information in a visual field of the driver. The display unit 60 includes, for example, a display device, an instrument panel, a wearable device such as an eyeglass-type display worn by the driver, a projector, and the like. The display unit 60 performs display under the control of a presentation control unit 4 described later.

The sound output unit 61 includes, for example, a speaker, an alarm, a buzzer, and the like. The sound output unit 61 outputs audio information, notification sound, warning sound, and the like under the control of the presentation control unit 4 described later.

The light emitting unit 62 includes, for example, a light emitting device such as a lamp. The light emitting unit 62 can function as, for example, a warning lamp, and the light emitting unit 62 turns on or blinks light for the purpose of notifying the driver of various types of information, warning, or the like under the control of the presentation control unit 4 described later.

### (Vehicle State Detection Unit)

The vehicle state detection unit 5 detects a state of the vehicle. The vehicle state detection unit 5 includes, for example, a gyro sensor, an acceleration sensor, and a sensor for detecting an operation amount of an accelerator pedal, an operation amount of a brake pedal, a steering angle, an engine speed, a motor speed, a rotation speed of the vehicle, or the like. Vehicle information such as a speed and a steering angle of the vehicle 1 detected by the vehicle state detection unit 5 is output to the presentation control unit 4 described later.

### (Information Processing Apparatus)

The information processing apparatus 10a has a hardware configuration necessary for a computer, such as, for example, a CPU, a memory (RAM, ROM), and the like. In the information processing apparatus 10a, the CPU loads a program stored in a storage unit 7 described later into the RAM and executes the program, thereby executing various types of processing including the image recognition processing according to the present technology.

In the information processing apparatus 10a, semantic segmentation (first task) is performed for each input image from the imaging unit 20 of each of the plurality of sensor units 2. Then, using a semantic segmentation result, a task (second task) to be used for the image recognition processing is determined, and a parameter for the task is generated.

The information processing apparatus 10a includes the processing unit 3, an image acquisition unit 30, the presentation control unit 4, the storage unit 7, and a situation analysis unit 8.

### ((Image Acquisition Unit))

The image acquisition unit 30 acquires an image acquired by the imaging unit 20 of each sensor unit 2. The image is output to the processing unit 3.

### ((Processing Unit))

The processing unit 3 performs recognition processing on the image (input image) acquired by the image acquisition unit 30. At this time, as described in the first embodiment, the processing unit 3 uses a result of execution of the first task performed on the input image, to determine whether or not to execute the second task and generate parameters for the second task.

Also in the present embodiment, similarly to the first embodiment, an example will be described in which the first task is semantic segmentation, and the second task is object detection (instance segmentation), motion detection (optical flow), and distance detection. In FIG. 4, in order to distinguish these second tasks, the object detection is defined as a second task a, the motion detection is defined as a second task b, and the distance detection is defined as a second task c.

Details will be described below.

The processing unit 3 includes a feature extraction unit 31, a first task estimation unit 32, a second task determination unit 33, a parameter generation unit 34, a second task neural network configuration unit 35, and a second task estimation unit 36.

The feature extraction unit 31 extracts a plurality of feature amounts of the input image with a feature extractor 37. Details of the feature extraction will be described later.

The first task estimation unit 32 executes the semantic segmentation as the first task. A semantic segmentation result is output to the second task determination unit 33 and the situation analysis unit 8. The semantic segmentation will be described later in detail.

On the basis of the semantic segmentation result, the second task determination unit 33 determines whether or not to execute each of the second task a, the second task b, and the second task c. Specific second task determination will be described later.

On the basis of the semantic segmentation result, the parameter generation unit 34 generates a parameter for the time of executing the second task determined to be executed. The generated parameter is stored in the storage unit 7. Specific parameter generation will be described later.

The second task neural network configuration unit 35 reads the parameter generated by the parameter generation unit 34 from the storage unit 7, and configures a neural network of the second task using the parameter.

The second task estimation unit 36 executes second task processing using the configured neural network. A processing result of the second task (recognition result of the input image) is output to the situation analysis unit 8.

The second task estimation unit 36 includes a second task a estimation unit 361, a second task b estimation unit 362, and a second task c estimation unit 363. The second task a estimation unit 361 performs the instance segmentation to detect an object. The second task b estimation unit 362 performs the optical flow to detect movement of an object. The second task c estimation unit 363 executes the distance detection. Details of the object detection, the motion detection, and the distance detection will be described later.

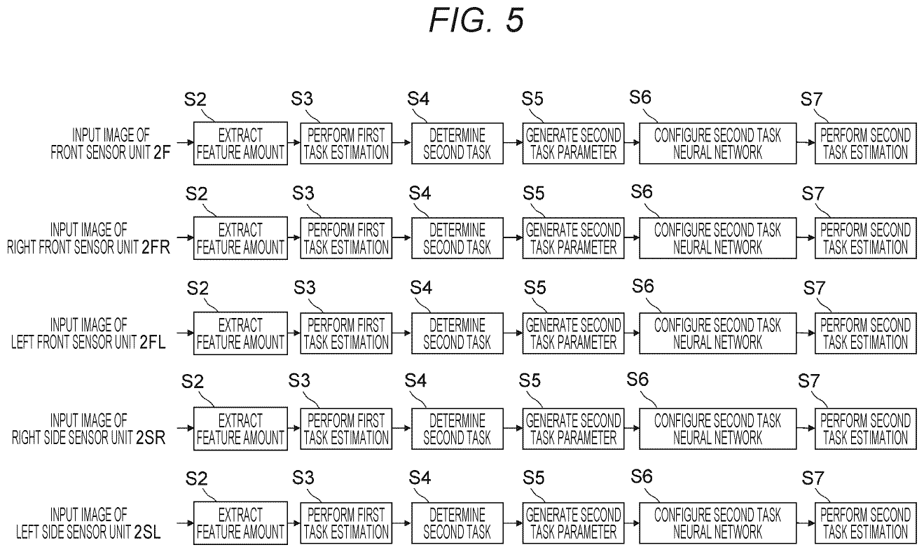

FIG. 5 is a schematic flowchart illustrating an image recognition processing example performed by the processing unit 3 on an image acquired by each of the plurality of sensor units 2 mounted on the vehicle 1 in the second and third embodiments.

As illustrated in FIG. 5, the image recognition processing (information processing) of the present technology is applied to an image acquired by each of the five sensor units of the front sensor unit 2F, the right front sensor unit 2FR, the left front sensor unit 2FL, the right side sensor unit 2SR, and the left side sensor unit 2SL. That is, in the processing unit 3, the processing of S1 to S6 described in the first embodiment is performed on each of input images from the plurality of sensor units 2.

In the image recognition processing on each of the images acquired by the plurality of sensor units 2, whether or not to execute the second task, which is another task, is determined on the basis of a recognition processing result of the first task. Therefore, the arithmetic amount of the entire recognition processing can be reduced without deteriorating recognition accuracy, and power consumption can be reduced and a processing delay can be suppressed.

### ((Situation Analysis Unit))

The situation analysis unit 8 performs analysis processing on a peripheral situation of the vehicle on the basis of a recognition processing result (semantic segmentation result) of the first task and a recognition processing result (one or more processing results selected from an object detection result, a motion detection result, and a distance detection result) of the second task. The analysis result is output to the presentation control unit 4.

### ((Presentation Control Unit))

The presentation control unit 4 generates driving assistance information by using the analysis result output from the situation analysis unit 8 and state information of the vehicle 1 detected by the vehicle state detection unit 5, and controls the presentation unit 6 that presents the driving assistance information.

The presentation control unit 4 includes, for example, a display control unit 40, an audio control unit 41, and a light emission control unit 42.

The display control unit 40 controls display on the display unit 60.

The audio control unit 41 controls audio output of the sound output unit 61.

The light emission control unit 42 controls lighting of the light emitting unit 62.

An analysis result by the situation analysis unit 8 described above is generated using an image recognition processing result in the processing unit 3. As described above, since the processing unit 3 can perform the image recognition processing in which high recognition accuracy is maintained while reducing the arithmetic amount, a result of analysis on the peripheral situation of the vehicle performed using the highly accurate image recognition processing result is highly accurate information. Then, the driving assistance information generated using such highly accurate information is information suitable for a situation surrounding the vehicle 1, and the driver can drive more safely using the driving assistance information.

Furthermore, in the processing unit 3 of the information processing apparatus 10a of the present technology, since the arithmetic amount of the image recognition processing can be reduced, a processing delay is suppressed, and accurate driving assistance information can be presented at a more accurate timing.

### ((Storage Unit))

The storage unit 7 stores various programs and data necessary for processing in the information processing apparatus 10a. For example, the storage unit 7 stores a program for executing a series of processing related to the image recognition processing performed by the processing unit 3 of the present technology. For example, the storage unit 7 stores various parameters to be used in the processing related to the image recognition processing, logs related to traveling and the like of the vehicle, and the like. For example, the storage unit 7 stores a program for executing a series of processing performed by the situation analysis unit 8 and the presentation control unit 4.

The storage unit 7 includes, for example, a read only memory (ROM), a random access memory (RAM), a magnetic storage device such as a hard disc drive (HDD), a semiconductor storage device, an optical storage device, a magneto-optical storage device, and the like.

### [Feature Extraction]

Feature extraction performed by the feature extraction unit 31 will be described.

FIG. 6 is a diagram schematically illustrating a configuration of the image recognition processing performed by the processing unit 3 of the information processing apparatus 10a, and is a schematic diagram for describing a neural network for feature extraction.

As illustrated in FIG. 6, a plurality of feature amounts f1 to f5 common to four tasks is extracted from an input image 9 acquired by the sensor unit 2, by using the feature extractor 37 constituting the feature extraction unit 31. As the common feature amount of the four tasks, a color feature and an edge feature of the input image are extracted by the feature extractor 37 of the neural network.

By the feature extractor 37, basic feature maps b0, b1, b2, and b3 having different resolutions are obtained from the input image 9, by using processing in a plurality of mutually different combination layers of convolution operation and an activation function.

The basic feature maps b0 and b1 of layers closer to the input image have relatively high resolutions and have detailed structure information of the image. Whereas, the basic feature maps b2 and b3 of layers farther from the input image have relatively low resolutions and have rough structure information of the image.

Moreover, the feature amounts f1 to f5 are extracted from two adjacent basic feature maps by the convolution operation. The feature amounts f1 to f5 are final feature maps, and are referred to as “feature amounts” in the present specification to be distinguished from the basic feature map.

For example, the feature amount f1 is extracted by the convolution operation using the basic feature maps b0 and b1. The feature amount f2 is extracted by the convolution operation using the basic feature map b2 and the feature amount f1. The feature amount f3 is extracted by the convolution operation using the basic feature map b3 and the feature amount f2. The feature amount f4 is extracted by the convolution operation using the feature amount f3. The feature amount f5 is extracted by the convolution operation using the feature amount f4.

The feature amounts f1 and f2 have relatively high resolutions and have more detailed color and edge information, and the feature amounts f3 to f5 have relatively low resolutions but have edge information in a wider range. The resolution decreases in an order of the feature amounts f1, f2, f3, f4, and f5.

The feature extractor 37 learns a sum of loss functions of the four tasks of the semantic segmentation, the object detection (instance segmentation), the motion detection (optical flow), and the distance (depth) detection, and minimizes the loss functions of all the tasks, thereby extracting the common feature amounts f1 to f5 of the four tasks.

In the information processing apparatus 10a, four types of task processing of the semantic segmentation, the object detection, the motion detection, and the distance detection can be executed using the extracted feature amounts f1 to f5.

As illustrated in FIG. 6, a semantic segmentation result 11 is obtained as an image recognition processing result obtained by the semantic segmentation. The semantic segmentation result 11 is an image in which labels or categories are associated with all pixels in the image.

By the object detection (instance segmentation), an object detection result 12 is obtained as an image recognition processing result.

By the motion detection (optical flow), an optical flow result 13 is obtained as an image recognition processing result.

By the distance detection, a distance detection result 14 is obtained as an image recognition processing result.

### [Semantic Segmentation (Class Classification)]

FIG. 7 is a diagram schematically illustrating a neural network 101 for semantic segmentation. The first task estimation unit 32 performs the semantic segmentation using the neural network 101 for semantic segmentation (first task).

The first task estimation unit 32 performs the semantic segmentation to divide, on a pixel basis, the input image 9 into regions such as a road surface, a sidewalk, the sky, a pedestrian, a vehicle, a cyclist, a building, a curbstone, a plant, a guardrail, a utility pole, a sign, a traffic signal, an animal, a trash bin, and a pole.

In the semantic segmentation, N classes of 1 to N are defined in advance, a probability of being each of the classes 1 to N is estimated for each pixel, and a class with the highest probability is set as an estimation result of the class of the pixel. A class ID is assigned to each class. More specifically, the estimation is performed as follows.

As illustrated in FIG. 7, each of the feature amounts f1 to f5 of the input image 9 output from the feature extractor 37 is output to a corresponding decoder. That is, the feature amount f1 is output to a first decoder 111. The feature amount f2 is output to a second decoder 112. The feature amount f3 is output to a third decoder 113. The feature amount f4 is output to a fourth decoder 114. The feature amount f5 is output to a fifth decoder 115.

Next, a class estimation feature map for each pixel is estimated using a convolutional neural network of each decoder.

Next, five class estimation feature maps estimated by the respective decoders and having different resolutions are aggregated by a feature aggregation unit 116. The aggregation is performed by connecting a sum of the individual pixels or the five class estimation feature maps in a channel direction.

Next, a class predictor 117 calculates a probability of being each of classes 1 to N for each pixel by the convolution operation such that the number of channels of the feature map aggregated by the feature aggregation unit 116 becomes N, which is the number of classes. The class ID corresponding to the highest probability among the N probability values is to be the semantic segmentation result (estimation result).

In this manner, the class IDs of all the pixels in the input image 9 are estimated, and the semantic segmentation result 11 is obtained.

### [Object Detection (Instance Segmentation)]

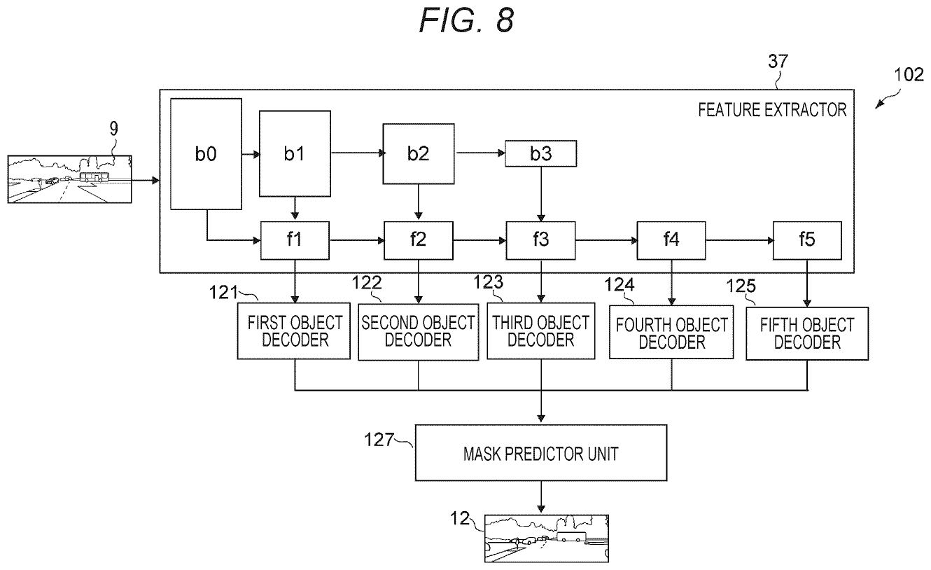

FIG. 8 is a diagram schematically illustrating a neural network 102 for object detection (instance segmentation). The second task a estimation unit 361 performs the instance segmentation using the neural network 102 for object detection.

In the instance segmentation, a mask for each object included in the input image 9 is detected, and a type (class) of a region thereof is also estimated. In the instance segmentation, even when a plurality of objects of the same class is adjacent with each other, a mask for each object can be detected.

As illustrated in FIG. 8, each of the feature amounts f1 to f5 of the input image 9 output from the feature extractor 37 is output to a corresponding decoder. That is, the feature amount f1 is output to a first object decoder 121. The feature amount f2 is output to a second object decoder 122. The feature amount f3 is output to a third object decoder 123. The feature amount f4 is output to a fourth object decoder 124. The feature amount f5 is output to a fifth object decoder 125.

Next, a bounding box and a class of the bounding box for each object are estimated using a convolutional neural network of each decoder.

Next, a feature amount of a bounding box region is cut out from the feature amount (any one of f1 to f5) corresponding to the bounding box from a position of the bounding box estimated by each decoder, and the cut out feature amount is output to a mask predictor unit 127.

Next, the mask predictor unit 127 estimates a class for each object region on the basis of the feature amount of the bounding box region.

As described above, the object detection result 12 subjected to the image recognition processing is obtained from the input image 9.

### [Motion Detection (Optical Flow)]

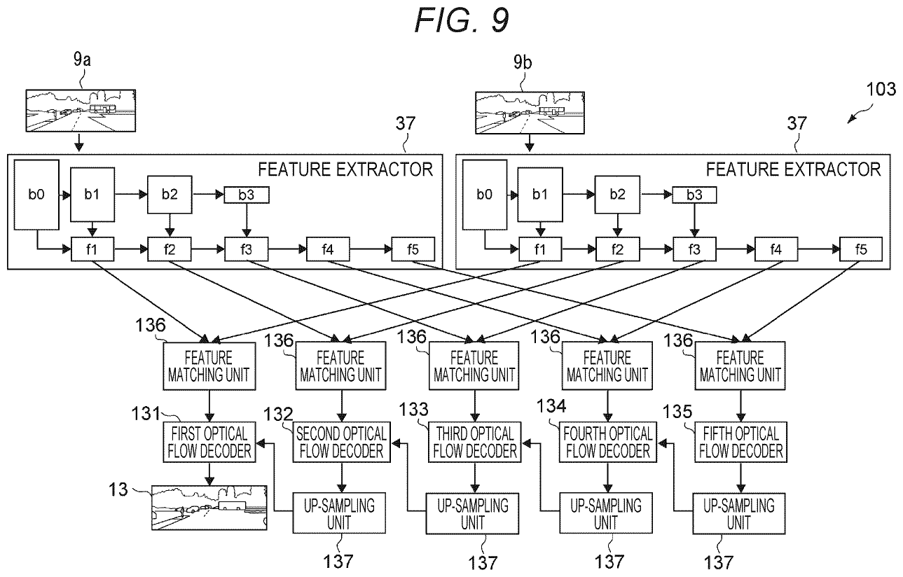

FIG. 9 is a diagram schematically illustrating a neural network 103 for motion detection (optical flow). The second task b estimation unit 362 performs the optical flow estimation using the neural network 103 for motion detection.

As illustrated in FIG. 9, in the optical flow, a movement amount for each pixel between two input images 9a and 9b is calculated. The two input images 9a and 9b are images acquired by the same sensor unit 2, and are, for example, an image of a current frame and an image of a previous frame.

As illustrated in FIG. 9, the feature extractor 37 extracts the feature amounts f1 to f5 from each of the two input images 9a and 9b.

Next, the feature amount f5 extracted from the input image 9a and the feature amount f5 extracted from the input image 9b are matched by a feature matching unit 136. The feature matching unit 136 associates feature amounts extracted individually from different images. A matching result is input to a fifth optical flow decoder 135. The fifth optical flow decoder 135 calculates an optical flow having the same resolution as the feature amount f5.

Next, the feature amount f4 extracted from the input image 9a and the feature amount f4 extracted from the input image 9b are matched by the feature matching unit 136. A matching result is output to a fourth optical flow decoder 134. Moreover, the optical flow calculated by the fifth optical flow decoder 135 and then up-sampled and enlarged by an up-sampling unit 137 is output to the fourth optical flow decoder 134. Then, the fourth optical flow decoder 134 calculates an optical flow having the same resolution as the feature amount f4. Here, when the optical flow is calculated by the fourth optical flow decoder 134, the enlarged optical flow after being calculated by the fifth optical flow decoder 135 is also used, whereby a more accurate optical flow can be calculated.

Next, the feature amount f3 extracted from the input image 9a and the feature amount f3 extracted from the input image 9b are matched by the feature matching unit 136. A matching result is output to a third optical flow decoder 133. Moreover, the optical flow calculated by the fourth optical flow decoder 134 and then up-sampled and enlarged by the up-sampling unit 137 is output to the third optical flow decoder 133. Then, the third optical flow decoder 133 calculates an optical flow having the same resolution as the feature amount f3. Similarly to the above, when the optical flow is calculated by the third optical flow decoder 133, the enlarged optical flow after being calculated by the fourth optical flow decoder 134 is also used, whereby a more accurate optical flow can be calculated.

Next, the feature amount f2 extracted from the input image 9a and the feature amount f2 extracted from the input image 9b are matched by the feature matching unit 136. A matching result is output to a second optical flow decoder 132. Moreover, the optical flow calculated by the third optical flow decoder 133 and then up-sampled and enlarged by the up-sampling unit 137 is output to the second optical flow decoder 132. Then, the second optical flow decoder 132 calculates an optical flow having the same resolution as the feature amount f2. Similarly to the above, when the optical flow is calculated by the second optical flow decoder 132, the enlarged optical flow after being calculated by the third optical flow decoder 133 is also used, whereby a more accurate optical flow can be calculated.

Next, the feature amount f1 extracted from the input image 9a and the feature amount f1 extracted from the input image 9b are matched by the feature matching unit 136. A matching result is output to a first optical flow decoder 131. Moreover, the optical flow calculated by the second optical flow decoder 132 and then up-sampled and enlarged by the up-sampling unit 137 is output to the first optical flow decoder 131. Then, the first optical flow decoder 131 calculates an optical flow having the same resolution as the feature amount f1. Similarly to the above, when the optical flow is calculated by the first optical flow decoder 131, the enlarged optical flow after being calculated by the second optical flow decoder 132 is also used, whereby a more accurate optical flow can be calculated. In this way, by calculating an optical flow together with an output of an optical flow decoder calculated in the previous stage, it is possible to obtain a highly accurate optical flow result (motion detection result).

As described above, the optical flow result 13 is obtained from the input images 9a and 9b.

### [Distance Detection]

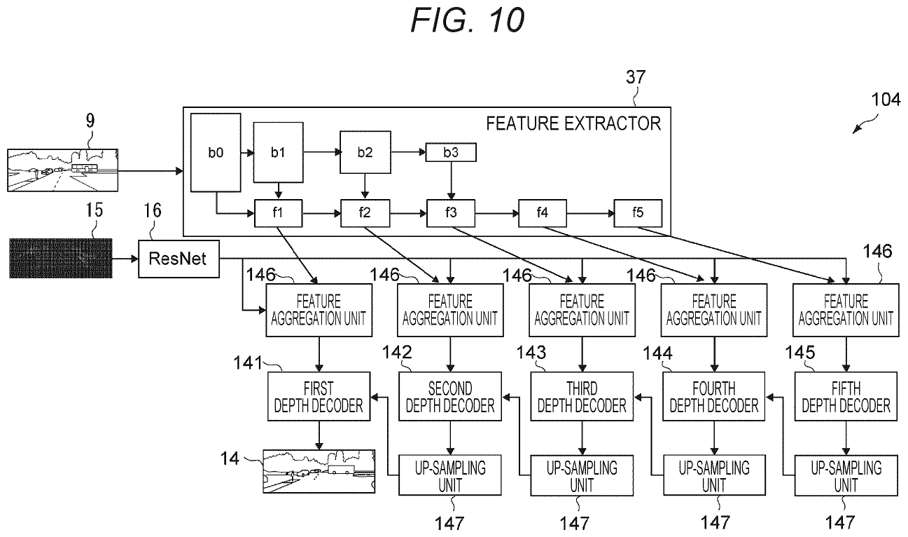

FIG. 10 is a diagram schematically illustrating a neural network 104 for distance detection. The second task c estimation unit 363 performs the distance estimation using the neural network 104 for distance detection (second task). In the distance estimation, depth information (distance information between an object and a vehicle) for each pixel is estimated from the input image 9.

As illustrated in FIG. 10, in the neural network 104 for distance detection, after each of the plurality of the feature amounts f1 to f5 having different resolutions extracted from the input image 9 and a feature amount extracted from a LiDAR point group 15 and acquired by the distance measurement unit 21 are aggregated, a distance (distance between the object and the vehicle (more specifically, the imaging unit)) for each pixel is calculated by a depth decoder which is a decoder for distance estimation. Details will be described below.

As illustrated in FIG. 10, the feature extractor 37 extracts the feature amounts f1 to f5 from the input image 9 acquired by the imaging unit 20 of the sensor unit 2. Furthermore, a LiDAR feature map (hereinafter, referred to as a LiDAR feature amount) is extracted for the LiDAR point group 15 acquired by the distance measurement unit 21 of the same sensor unit 2 using RestNet (He, Kaiming, et al. “Deep residual learning for image recognition. “Proceedings of IEEE conference on computer vision and pattern recognition. 2016) 16.

Next, the feature amount f5 extracted from the input image 9 and the LiDAR feature amount extracted from the LiDAR point group 15 are aggregated by a feature aggregation unit 146. The aggregation is performed with a sum for every pixel. Alternatively, the feature amounts of the individual pixels may be connected in a channel direction. An aggregation result (aggregated feature data) is output to a fifth depth decoder 145. The fifth depth decoder 145 calculates a distance detection result having the same resolution as the feature amount f5.

Next, the feature amount f4 extracted from the input image 9 and the LiDAR feature amount extracted from the LiDAR point group 15 are aggregated by the feature aggregation unit 146. An aggregation result is output to a fourth depth decoder 144. Moreover, the distance detection result calculated by the fifth depth decoder 145 and then up-sampled and enlarged by an up-sampling unit 147 is output to the fourth depth decoder 144. Then, the fourth depth decoder 144 calculates a distance detection result having the same resolution as the feature amount f4. Here, when the distance is calculated by the fourth depth decoder 144, the enlarged distance detection result after being calculated by the fifth depth decoder 145 is also used, so that a more accurate distance detection result can be calculated.

Next, the feature amount f3 extracted from the input image 9 and the LiDAR feature amount extracted from the LiDAR point group 15 are aggregated by the feature aggregation unit 146. An aggregation result is output to a third depth decoder 143. Moreover, the distance detection result calculated by the fourth depth decoder 144 and then up-sampled and enlarged by the up-sampling unit 147 is output to the third depth decoder 143. Then, the third depth decoder 143 calculates a distance detection result having the same resolution as the feature amount f3. Here, when the distance is calculated by the third depth decoder 143, the enlarged distance detection result after being calculated by the fourth depth decoder 144 is also used, so that a more accurate distance detection result can be calculated.

Next, the feature amount f2 extracted from the input image 9 and the LiDAR feature amount extracted from the LiDAR point group 15 are aggregated by the feature aggregation unit 146. An aggregation result is output to a second depth decoder 142. Moreover, the distance detection result calculated by the third depth decoder 143 and then up-sampled and enlarged by the up-sampling unit 147 is output to the second depth decoder 142. Then, the second depth decoder 142 calculates a distance detection result having the same resolution as the feature amount f2. Here, when the distance is calculated by the second depth decoder 142, the enlarged distance after being calculated by the third depth decoder 143 is also used, so that a more accurate distance can be calculated.

Next, the feature amount f1 extracted from the input image 9 and the LiDAR feature amount extracted from the LiDAR point group 15 are aggregated by the feature aggregation unit 146. An aggregation result is output to a first depth decoder 141. Moreover, the distance detection result calculated by the second depth decoder 142 and then up-sampled and enlarged by the up-sampling unit 147 is output to the first depth decoder 141. Then, the first depth decoder 141 calculates a distance detection result 14 having the same resolution as the feature amount f1. Here, when the distance is calculated by the first depth decoder 141, the enlarged distance detection result after being calculated by the second depth decoder 142 is also used, so that a more accurate distance detection result can be calculated. In this way, by calculating a distance detection result together with an output of a depth decoder calculated in the previous stage, it is possible to obtain a highly accurate distance detection result.

As described above, the distance detection result 14 is obtained from the image 9.

As described above, in the processing unit 3 of the information processing apparatus 10a, the four tasks (the semantic segmentation, the object detection, the motion detection, the distance detection) can be executed using the common feature extractor 37.

### [Information Processing Method (Image Recognition Processing Method)]

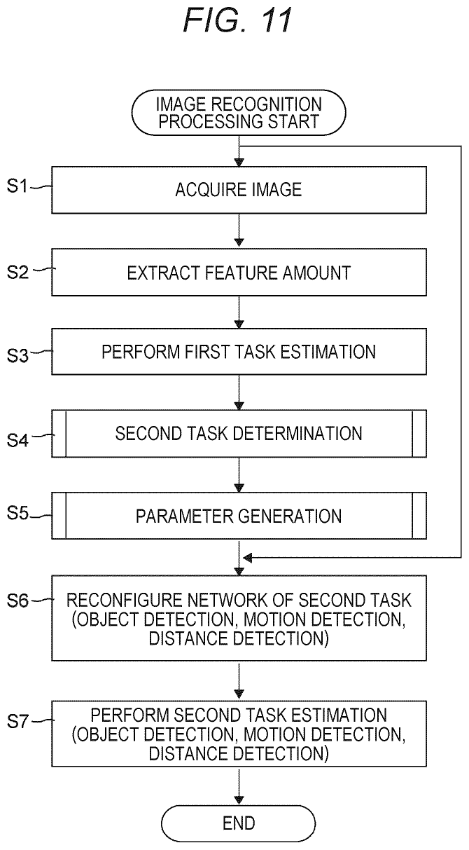

An information processing method (image recognition processing method) in the information processing apparatus 10a will be described with reference to FIG. 11. The information processing illustrated in FIG. 11 is performed on each image acquired by each sensor unit 2.

The image acquisition unit 30 acquires the image 9 captured by the imaging unit 20 of the sensor unit 2 (S1).

Next, the feature extraction unit 31 extracts a plurality of feature amounts (f1 to f5) of the image 9 (S2).

Next, the first task estimation unit 32 executes the first task (semantic segmentation) using the plurality of feature amounts extracted in S2 (S3).

Next, the second task determination unit 33 determines whether or not to execute the second task on the basis of a first task result (S4). In the present embodiment, the second task determination unit 33 determines whether or not to execute each of the object detection, the motion detection, and the distance detection.

Next, the parameter generation unit 34 generates a parameter for the second task determined to be executed, by using the semantic segmentation result (S5).

Next, the second task neural network configuration unit 35 configures a neural network of the second task by using the parameter generated in S5 (S6).

Next, the second task estimation unit 36 executes the second task (in the present embodiment, one or more tasks selected from the object detection, the motion detection, and the distance detection) by using the neural network configured in S6 (S7).

### [Determination of Second Task]

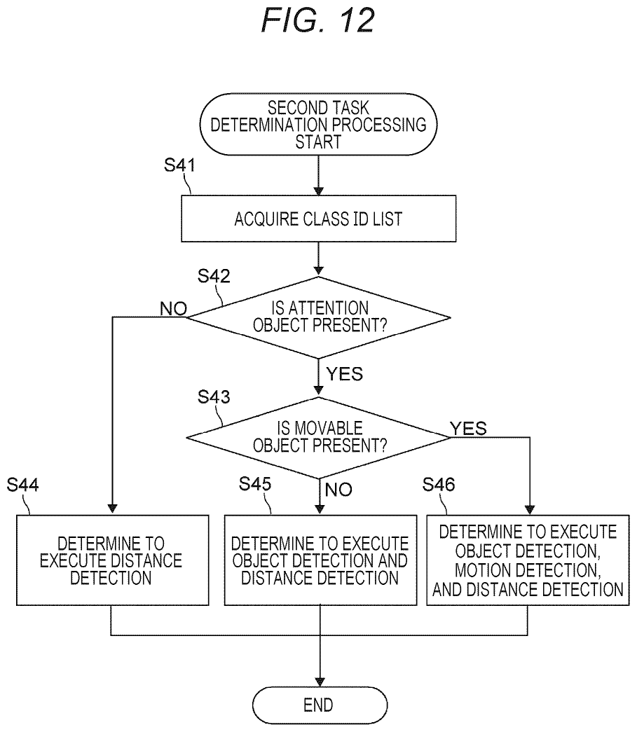

FIG. 12 is a flowchart of the second task determination processing in step 4 (S4) in FIG. 11 performed by the second task determination unit 33 of the processing unit 3. With reference to FIG. 12, how to determine the second task to be executed will be described below. The second task determination processing is performed on the basis of a first task processing result (semantic segmentation result).

As illustrated in FIG. 12, when the second task determination processing is started, a unique class ID list (hereinafter, simply referred to as an ID list) is acquired from the semantic segmentation result including class ID information for each pixel (S1).

Next, it is determined whether there is a class ID of an attention object by using the ID list (S42). When it is determined that there is an attention object, the processing proceeds to S43. When it is determined that there is no attention object, execution of only the distance detection is determined (S44).

Here, as an example, it is assumed that class IDs 1 to 13 are given individually in advance to a utility pole, a traffic signal, a traffic sign, a trash bin, a pole, a vehicle (four-wheeled automobile), a person, an animal, a bicycle, a motorcycle (two-wheeled automobile), a train, a bus, and a truck. These objects are attention objects (objects that hinder driving). Among these objects, the vehicle with the class ID 6, the person with the class ID 7, the animal with the class ID 8, the bicycle with the class ID 9, the motorcycle with the class ID 10, the train with the class ID 11, the bus with the class ID 12, and the track with the class ID 13 are movable attention objects. Whereas, the utility pole with the class ID 1, the traffic signal with the class ID 2, the traffic sign with the class ID 3, the trash bin with the class ID 4, and the pole with the class ID 5 are immovable attention objects.

For example, in a case where there is a class ID of any of 1 to 13 in the ID list in S42, the processing proceeds to S43. Whereas, in a case where there is no class ID of the class ID of any of 1 to 13 in the ID list, the processing proceeds to S44, and it is determined to execute only the distance detection task.

In S43, it is determined whether or not there is a class ID of a movable attention object in the ID list.

When it is determined that there is a class ID of a movable attention object, it is determined to execute the three tasks of the object detection, the motion detection, and the distance detection (S46).

Whereas, when it is determined that there is no class ID of a movable attention object, it is determined to execute the two tasks of the object detection and the distance detection (S45).

For example, in the example described above, in a case where there is a class ID of any of 5 to 13 in the ID list, the processing proceeds to S46, and it is determined to execute the three tasks of the object detection, the motion detection, and the distance detection.

Whereas, in a case where there is no class ID of any of 5 to 13 in the ID list, the processing proceeds to S45, and it is determined to execute the two tasks of the object detection and the distance detection.

As described above, in the present embodiment, it is determined whether or not to execute each of the object detection, the motion detection, and the distance detection, which are the second tasks, on the basis of the processing result (semantic segmentation result) of the first task.

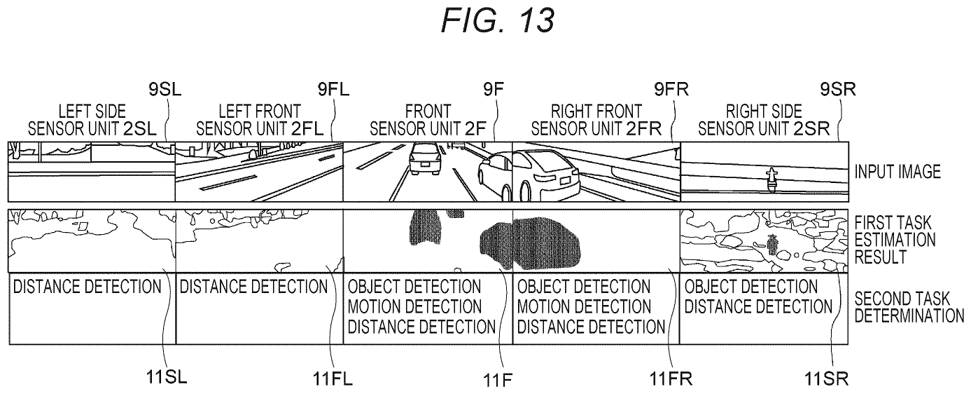

Next, with reference to FIG. 13, a specific example of the second task determination processing will be described.

FIG. 13 is a diagram for describing a specific example of the second task determination processing. FIG. 13 is a diagram for describing how to determine whether or not to execute the second task in accordance with the first task processing result for the image 9 acquired by the imaging unit 20 of each of the plurality of sensor units 2 mounted on the vehicle. In the second task determination processing, the second task to be executed is determined using a scene feature obtained from the semantic segmentation.

In the example illustrated in FIG. 13, both an image 9SL acquired by the imaging unit 20 of the left side sensor unit 2SL and an image 9FL acquired by the imaging unit 20 of the left front sensor unit 2FL are images in which there is no attention object.

Therefore, since a class ID of an attention object is not included in the ID list acquired from each of semantic segmentation results 11SL and 11FL which are first task estimation results for the images 9SL and 9FL, respectively, it is determined to execute only the distance detection.

In this way, in a case where there is no attention object, only the distance detection is executed, so that, for example, a distance between a road surface and the vehicle (the vehicle on which the imaging unit is mounted) can be estimated. It is possible to present driving assistance information such as a driving operation command, a speed change, a vehicle overtaking recommendation, and a lane change recommendation to the driver by using the estimated distance information between with an object that does not become an obstacle.

In the example illustrated in FIG. 13, both an image 9F acquired by the imaging unit 20 of the front sensor unit 2F and an image 9FR acquired by the imaging unit 20 of the right front sensor unit 2FR are images in which there is a vehicle that is a movable attention object.

Therefore, since a class ID of a movable attention object is included in the ID list acquired from each of semantic segmentation results 11F and 11FR, which are first task estimation results for the images 9F and 9FR, respectively, it is determined to execute the task of the object detection, the motion detection, and the distance detection.

As described above, in a case where there is a movable attention object, the object detection, the motion detection, and the distance detection are executed, whereby a motion and a distance (distance between the object and the vehicle) of each object can be estimated. By using the estimated motion information and distance information of each object, that is, the image recognition processing result, it is possible to present, to the driver, driving assistance information such as an obstacle warning, a driving operation command, a speed change, a vehicle overtaking recommendation, and a lane change recommendation.

In the example illustrated in FIG. 13, an image 9SR acquired by the imaging unit 20 of the right side sensor unit 2SR is an image in which there is a fire hydrant which is an immovable attention object.

Therefore, since a class ID of an immovable attention object is included in the ID list acquired from a semantic segmentation result 11SR, which is a first task estimation result for the image 9SR, it is determined to execute the object detection and the distance detection.

As described above, in a case where there is a stationary attention object that is immovable, such as a fire hydrant, a wall, a curbstone, or a pole, a distance between these objects and the vehicle can be estimated by executing the object detection and the distance detection. By using the estimated distance information, that is, the image recognition processing result, it is possible to present, to the driver, driving assistance information such as an obstacle warning and a driving operation command for avoiding collision with the obstacle.

Here, in an entire peripheral sensing system in which a plurality of imaging units is mounted on a vehicle and peripheral information of the vehicle is acquired in a wide range, for example, if the four tasks are always executed for one input image, the arithmetic amount becomes enormous and a processing delay is likely to occur, and real-time image recognition processing and driving assistance based on the image recognition result become difficult.

Whereas, in the present embodiment, by applying the image processing method (information processing method) of the present technology to each image acquired by each imaging unit, for example, all the three second tasks are executed only in a case where there is an object that is a movable obstacle as in the image acquired by the front sensor unit or the right front sensor unit illustrated in FIG. 13, and only two or one second task is executed in other cases. As a result, it is possible to reduce the arithmetic amount of the image recognition processing and suppress the processing delay.

### [Parameter Generation for Second Task]

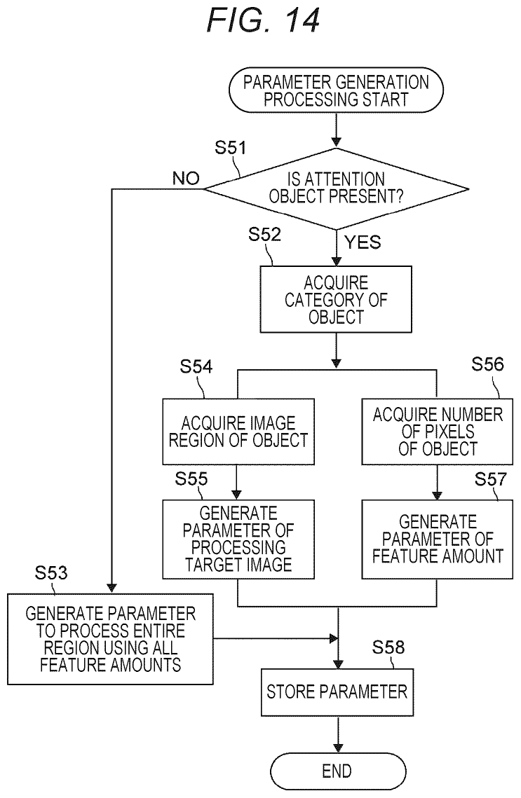

FIG. 14 is a flowchart of second task parameter generation processing in step 5 (S5) in FIG. 11 performed by the parameter generation unit 34 of the processing unit 3.

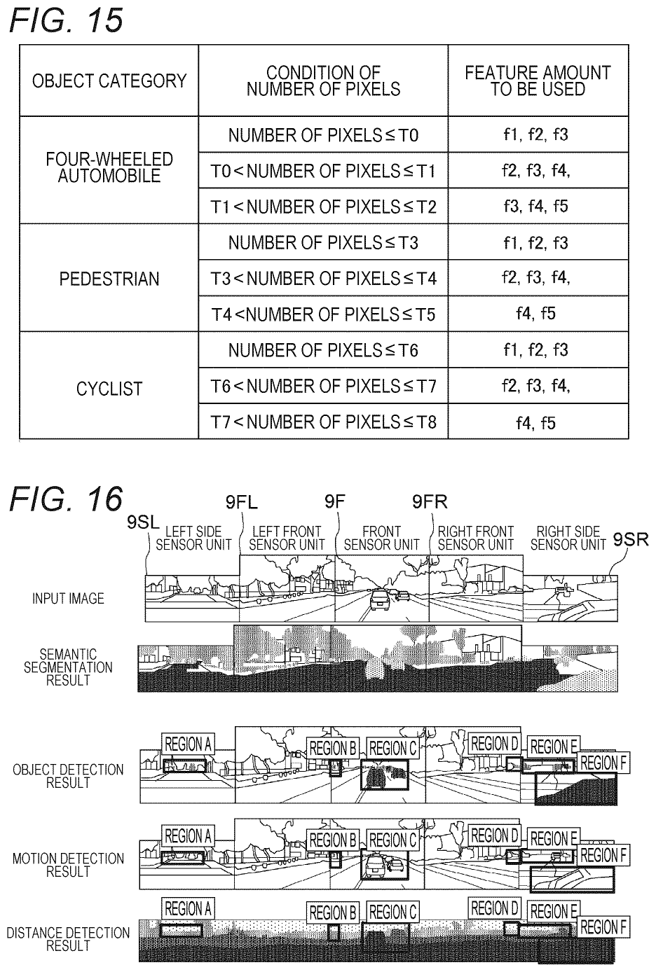

FIG. 15 is a table for describing a specific example of parameter generation.

With reference to FIG. 14 and FIG. 15, how to generate a parameter to be used at the time of execution of the second task will be described below. The parameter generation processing is performed using the first task processing result (semantic segmentation result).

As illustrated in FIG. 14, when the parameter generation processing is started, it is determined whether or not there is an attention object in an image on the basis of the semantic segmentation result (S51). Specifically, the presence or absence of the attention object can be determined by determining whether or not there is a class ID of an attention object, by using the ID list acquired from the semantic segmentation result.

When it is determined that there is no attention object in S51, the processing proceeds to S53.

When it is determined in S51 that there is an attention object, the processing proceeds to S52.

In S53, a parameter is generated such that recognition processing is performed on the entire region of the input image 9 by using all the feature amounts f1 to f5. The generated parameter is stored in the storage unit 7 (S58).

As described in the second task determination processing above, in a case where it is determined that there is no attention object, it is determined to execute only the distance detection. That is, in a case where there is no attention object, it is determined to execute only the distance detection, optimization is not performed on the neural network for distance detection, and the distance detection is performed on the entire region of the input image 9 by using all the feature amounts f1 to f5. In other words, the distance detection is performed using a standard neural network.

In S52, a category of the attention object is acquired. Specifically, the category can be acquired by checking the class ID of the attention object by using the ID list. There may be a plurality of objects in a category acquisition result. The category acquisition result is the class ID list of the attention object.

Next, the processing proceeds to S54 and S56.

In S54, an image region where there is the attention object is acquired. The acquired image region includes a region of each of the plurality of objects. A rectangular frame (also referred to as a bounding box) surrounding the attention object is provided, and a region (referred to as a minimum region) of the frame when the size of the frame becomes minimum is set as a final image region. This final image region is referred to as a “processing target image”. The processing target image is a processing target region on which the second task processing is to be performed.

Next, a coordinate parameter of the processing target image is generated (S55). The generated parameter is stored in the storage unit 7 (S58).

Coordinates of the processing target image are represented in a form of parameters (x1, y1, w, h). The parameters (x1, y1, w, h) are expressed by using coordinates (x1, y1) of an upper left corner of the rectangular frame (bounding box) and (w, h) indicating the number of horizontal and vertical pixels of the rectangle.

In S56, the number of pixels for each attention object acquired in S52 is calculated, and a minimum pixel number list is generated so as to include the minimum number of pixels for each category of the attention object.

Next, using the minimum pixel number list of the attention object, a parameter representing a feature amount to be used for the second task is generated (S57). The generated parameter is stored in the storage unit 7 (S58).

In the parameter generation, for example, a parameter of the feature amount is generated according to the table illustrated in FIG. 15.

In the example illustrated in FIG. 15, in a case where the object category is a four-wheeled automobile, the parameters are generated such that the feature amounts to be used become f1, f2, and f3 when the number of pixels is equal to or smaller than TO, the feature amounts to be used become f2, g3, and f4 when the number of pixels is larger than T0 and equal to or smaller than T1, and the feature amounts to be used become f3, f4, and f5 when the number of pixels is larger than T1 and equal to or smaller than T2.

In a case where the object category is a pedestrian, the parameters are generated such that the feature amounts to be used become f1, f2, and f3 when the number of pixels is equal to or smaller than T3, the feature amounts to be used become f2, g3, and f4 when the number of pixels is larger than T3 and equal to or smaller than T4, and the feature amounts to be used become f4 and f5 when the number of pixels is larger than T4 and equal to or smaller than T5.

In a case where the category of the attention object is a cyclist, the parameters are generated such that the feature amounts to be used become f1, f2, and f3 when the number of pixels is equal to or smaller than T6, the feature amounts to be used become f2, g3, and f4 when the number of pixels is larger than T6 and equal to or smaller than T7, and the feature amounts to be used become f4 and f5 when the number of pixels is larger than T7 and equal to or smaller than T8.

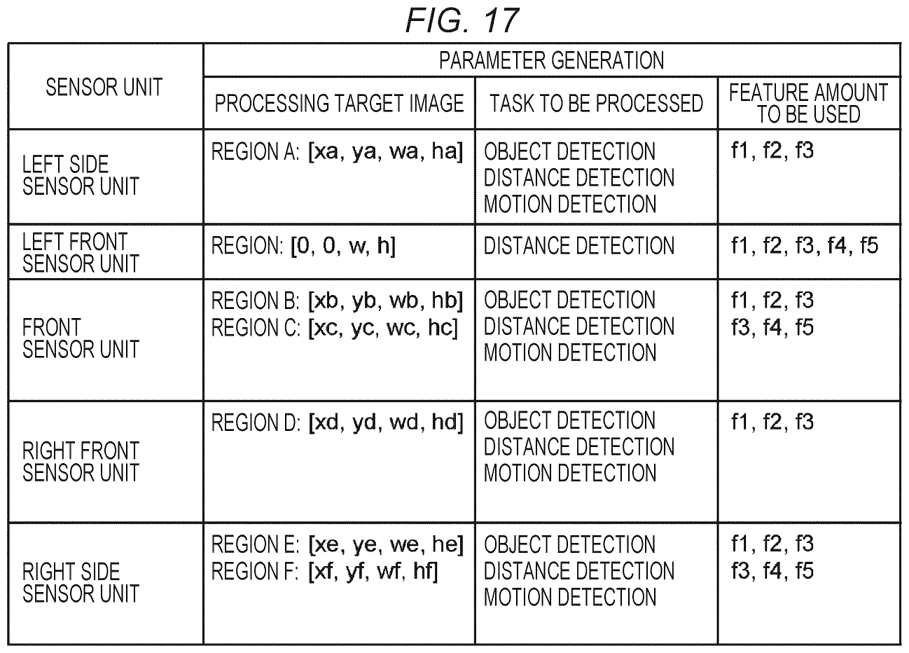

Next, a specific example of the parameter generation will be described with reference to FIGS. 16 and 17.

FIG. 16 is a diagram illustrating the image 9 acquired by each imaging unit of the plurality of sensor units 2 mounted on the vehicle 1, and a semantic segmentation result, an object detection result, a motion detection result, and a distance detection result for the image 9. In FIG. 2, the object detection result, the motion detection result, and the distance detection result are recognition processing results using the standard neural network or a neural network reconfigured and optimized with parameters generated on the basis of the semantic segmentation result.

FIG. 17 is a table illustrating an example of determination of the second task to be executed and parameter generation based on the semantic segmentation result illustrated in FIG. 16.

In the example illustrated in FIG. 16, the image 9SL acquired by the imaging unit 20 of the left side sensor unit 2SL is an image in which there is a movable attention object.

Therefore, as illustrated in FIG. 17, since a class ID of a movable attention object is included in the ID list acquired from the semantic segmentation result for the image 9SL, it is determined to execute all the second tasks of the object detection, the motion detection, and the distance detection. Furthermore, as parameters of the processing target image, parameters [xa, ya, wa, ha] indicating coordinates of a region A surrounded by a rectangular frame that surrounds the attention object in the figure is generated, and the parameters are generated such that the feature amounts f1, f2, and f3 are used. As described above, the parameter generation of the feature amount is generated according to the number of pixels of the attention object in accordance with FIG. 15, which similarly applies hereinafter.

In the example illustrated in FIG. 16, the image 9FL acquired by the imaging unit 20 of the left front sensor unit 2FL is an image in which there is no attention object.

Therefore, as illustrated in FIG. 17, since a class ID of an attention object is not included in the ID list acquired from the semantic segmentation result for the image 9FL, it is determined to execute only the distance detection. Furthermore, a parameter is generated such that the entire image is set as the processing target image and all the feature amounts f1 to f5 are used. In FIG. 17, the coordinates of the processing target image in the entire image are expressed as parameters [0, 0, w, h].

In the example illustrated in FIG. 16, the image 9F acquired by the imaging unit 20 of the front sensor unit 2F is an image in which there is a movable attention object.

Therefore, as illustrated in FIG. 17, since a class ID of a movable attention object is included in the ID list acquired from the semantic segmentation result for the image 9F, it is determined to execute all the second tasks of the object detection, the motion detection, and the distance detection. Furthermore, as parameters of the processing target image, parameters [xb, yb, wb, hb] indicating coordinates of a region B surrounded by a rectangular frame that surrounds the attention object in the figure and parameters [xc, yc, wc, hc] indicating coordinates of a region C are generated. Furthermore, the parameters are generated such that the feature amounts f1, f2, and f3 are used for the region B, and the parameters are generated such that the feature amounts f3, 14, and f5 are used for the region C.

In the example illustrated in FIG. 16, the image 9FR acquired by the imaging unit 20 of the right front sensor unit 2FR is an image in which there is a movable attention object.

Therefore, as illustrated in FIG. 17, since a class ID of a movable attention object is included in the ID list acquired from the semantic segmentation result for the image 9FR, it is determined to execute all the second tasks of the object detection, the motion detection, and the distance detection. Furthermore, as parameters of the processing target image, parameters [xd, yd, wd, hd] indicating coordinates of a region D surrounded by a rectangular frame that surrounds the attention object in the figure is generated, and the parameters are generated such that the feature amounts f1, f2, and f3 are used.

In the example illustrated in FIG. 16, the image 9SR acquired by the imaging unit 20 of the right side sensor unit 2SR is an image in which there is a movable attention object.

Therefore, as illustrated in FIG. 17, since a class ID of a movable attention object is included in the ID list acquired from the semantic segmentation result for the image 9SR, it is determined to execute all the second tasks of the object detection, the motion detection, and the distance detection. Furthermore, as parameters of the processing target image, parameters [xe, ye, we, he] indicating coordinates of a region E surrounded by a rectangular frame that surrounds the attention object in the figure and parameters [xf, yf, wf, hf] indicating coordinates of a region F are generated. Furthermore, the parameters are generated such that the feature amounts f1, f2, and f3 are used for the region E, and the parameters are generated such that the feature amounts f3, 14, and f5 are used for the region F.

### [Neural Network Configuration of Second Task]

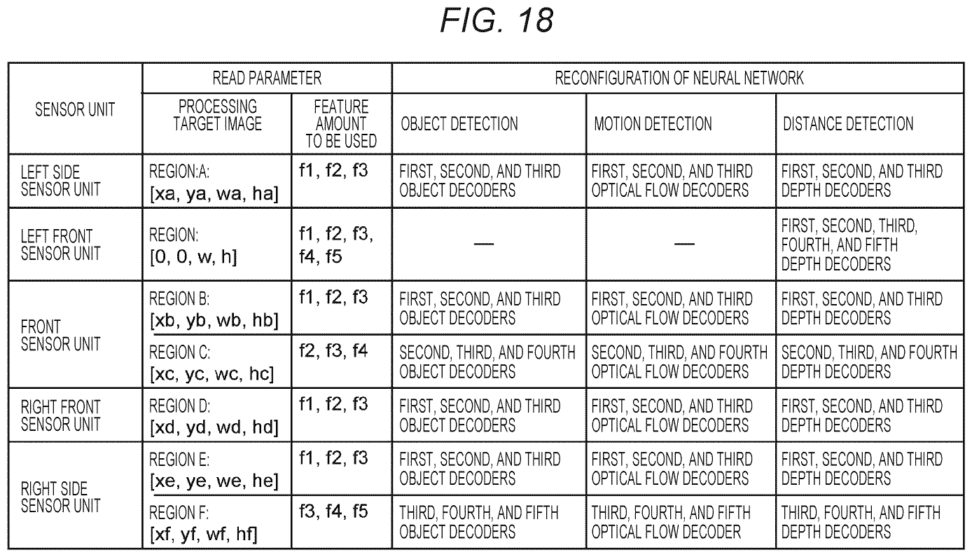

FIG. 18 is a table illustrating an example of neural network configuration performed by the second task neural network configuration unit 35 of the processing unit 3.

FIG. 18 illustrates an example in which, in the recognition task for each input image illustrated in FIG. 16, a neural network is configured using the second tasks determined to be executed and parameters illustrated in FIG. 17.

By reconfiguring the neural network of the second task using the generated parameters, estimation processing of the second task determined to be executed in S33 can be performed with a small arithmetic amount in accordance with a size of the attention object shown in the input image, and the estimation processing can be further optimized. In the configuration of the neural network, the configuration is changed so as to select the decoder of each second task by using the generated parameters.

Hereinafter, a specific example will be described with reference to FIG. 18.

For the image 9SL acquired by the left side sensor unit 2SL, it is determined to execute all the three recognition tasks (second tasks) of the object detection, the motion detection processing, and the distance detection, by the second task determination processing as described above.

In execution of these three second tasks, as illustrated in FIG. 18, the processing target image is only the region A [xa, ya, wa, ha]. Furthermore, since only a small object located far away is present in the region A, the neural network of each second task is configured to generate only the feature amounts f1, f2, and f3 with a high resolution, and accordingly, the neural network of each second task is reconfigured to set only the decoders corresponding to f1, f2, and f3 as decoders to be used in the processing of the second task. More specifically, in the object detection, the neural network is reconfigured to use only the first, second, and third object decoders 121 to 123. In the motion detection, the neural network is reconfigured to use only the first, second and third optical flow decoders 131 to 133. In the distance detection, the neural network reconfigured to use only the first, second, and third depth decoders 141 to 143.

For the image 9FL acquired by the left front sensor unit 2FL, it is determined to execute only the distance detection by the second task determination processing as described above. In the execution of the distance detection, as illustrated in FIG. 18, the processing target image is the entire region, and the neural network for distance detection is configured to generate the feature amounts f1 to f5. Accordingly, the neural network for distance detection is configured to set the decoders corresponding to the feature amounts f1 to f5 as decoders to be used in the distance detection. More specifically, the neural network is configured to use the first to fifth depth decoders 141 to 145. That is, the optimization is not performed, and the distance detection is performed using the standard neural network.

For the image 9F acquired by the front sensor unit 2F, it is determined to execute all the three recognition tasks (second tasks) of the object detection, the motion detection processing, and the distance detection by the second task determination processing as described above.

In execution of these three second tasks, as illustrated in FIG. 18, the processing target image is only the region B[xb, yb, wb, hb] and the region C[xc, yc, wc, hc].

In the region B, since only a small object located far away is present in the region B, the neural network of each second task is configured to generate only the feature amounts f1, f2, and f3 with a high resolution, and accordingly, the neural network of each second task is reconfigured to set only the decoders corresponding to f1, f2, and f3 as decoders to be used in the second task.

Whereas, in the region C, since there is a large object located close to the region C, the neural network of each second task is configured to generate only the feature amounts f2, f3, and f4 having a low resolution but having a wide range of edge information, and accordingly, the neural network of each second task is reconfigured to set only the decoders corresponding to f2, f3, and f4 as decoders to be used in the second task.

Specifically, in the object detection, the neural network is reconfigured to use only the first, second, and third object decoders 121 to 123 in the region B, and use only the second, third, and fourth object decoders 122 to 124 in the region C. In the motion detection, the neural network is configured to use only the first, second and third optical flow decoders 131 to 133 in the region B, and reconfigured to use only the second, third and fourth optical flow decoders 132 to 134 in the region C. In the distance detection, the neural network is configured to use only the first, second, and third depth decoders 141 to 143 in the region B, and reconfigured to use only the second, third, and fourth depth decoders 142 to 144 in the region C.

For the image 9SL acquired by the left side sensor unit 2SL, it is determined to execute all the three recognition tasks (second tasks) of the object detection, the motion detection processing, and the distance detection, by the second task determination processing as described above.

In execution of these three second tasks, as illustrated in FIG. 18, the processing target image is only the region D [xd, yd, wd, hd]. Furthermore, since only a small object located far away is present in the region D, the neural network of each second task is configured to generate only the feature amounts f1, f2, and f3 with a high resolution, and accordingly, the neural network of each second task is reconfigured to set only the decoders corresponding to f1, f2, and f3 as decoders to be used in the second task. More specifically, in the object detection, the neural network is reconfigured to use only the first, second, and third object decoders 121 to 123. In the motion detection, the neural network is reconfigured to use only the first, second and third optical flow decoders 131 to 133. In the distance detection, the neural network reconfigured to use only the first, second, and third depth decoders 141 to 143.

For the image 9SR acquired by the right side sensor unit 2SR, it is determined to execute all the three recognition tasks (second tasks) of the object detection, the motion detection processing, and the distance detection by the second task determination processing as described above.

In execution of these three second tasks, as illustrated in FIG. 18, the processing target image is only a region E [xe, ye, we, he] and a region F [xf, yf, wf, hf].

In the region E, since only a small object located far away is present in the region E, the neural network of each second task is configured to generate only the feature amounts f1, f2, and f3 with a high resolution, and accordingly, the neural network of each second task is reconfigured to set only the decoders corresponding to f1, f2, and f3 as decoders to be used in the second task.

Whereas, in the region F, there is a large object located close to the region F. Therefore, the neural network of each second task is configured to generate only the feature amounts f2, f3, and f4 having a low resolution but having a wide range of edge information, and accordingly, the neural network of each second task is reconfigured to set only the decoders corresponding to f2, f3, and f4 as decoders to be used in the second task.

Specifically, in the object detection, the neural network is configured to use only the first, second, and third object decoders 121 to 123 in the region E, and use only the second, third, and fourth object decoders 122 to 124 in the region F. In the motion detection, the neural network is configured to use only the first, second, and third optical flow decoders 131 to 133 in the region E, and use only the second, third, and fourth optical flow decoders 132 to 134 in the region F. In the distance detection, the neural network is configured to use only the first, second, and third depth decoders 141 to 143 in the region E, and use only the second, third, and fourth depth decoders 142 to 144 in the region F.

As described above, in the present technology, the arithmetic amount can be reduced by extracting the five feature amounts f1 to f5 that can be used in common in a plurality of tasks. Furthermore, since it is possible to determine the second task to be executed and generate parameters in accordance with a processing result of the first task, a neural network of the second task can be optimized. As a result, for example, the arithmetic amount on the decoder side can be reduced as compared with the processing in the standard neural network.

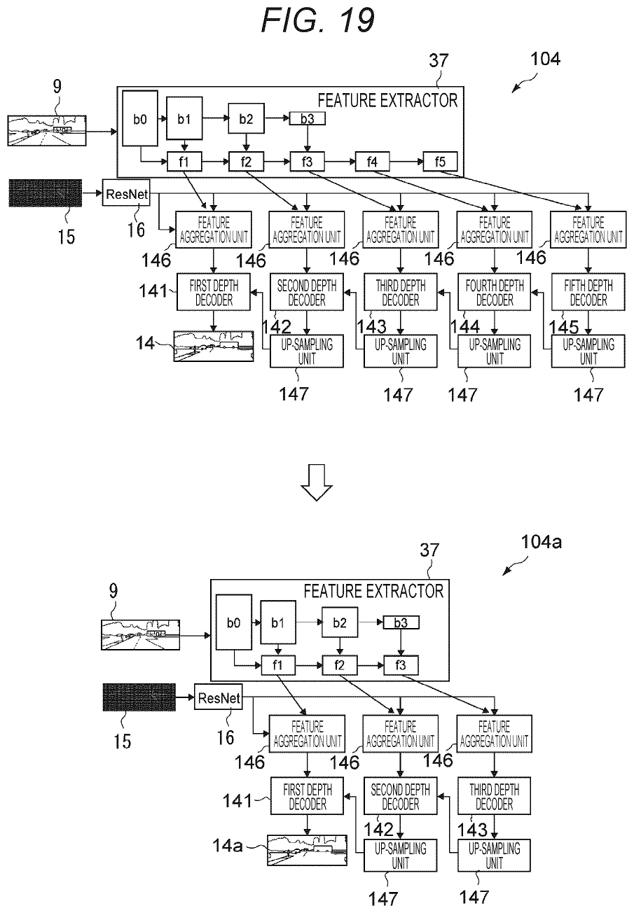

With reference to FIG. 19, with the distance detection taken as an example, a description is given to that the arithmetic amount on the decoder side can be reduced.

Here, the distance detection performed on the image 9SL, which is acquired by the left side sensor unit 2SL and illustrated in FIGS. 16 and 17 and has a movable attention object, will be described as an example.

The upper part of FIG. 19 is a diagram illustrating the standard neural network 104, and has a configuration similar to that of FIG. 10 described above.

The lower part of FIG. 19 is a diagram illustrating a neural network 104a that is reconfigured using the feature amounts f1, f2, and f3 generated as parameters, when only the distance detection is determined to be executed on the basis of a semantic segmentation result.

As illustrated in FIG. 19, in the reconfigured neural network 104a for distance detection, the number of decoders to be used is smaller than that of the standard neural network 104. As a result, the distance detection processing (second task processing) is optimized, and the arithmetic amount on the decoder side can be reduced.

Furthermore, also in the object detection and the motion detection, the neural network can be similarly reconfigured, and the arithmetic amount on the decoder side can be reduced by reducing the number of decoders to be used as compared with the standard neural network.

Note that, in a case where there is no attention object, the task processing is performed using the standard neural network.

As described above, in the present technology, only a necessary recognition task (second task) is processed according to a scene feature based on a semantic segmentation result. Moreover, a parameter is generated using the semantic segmentation result, and a neural network of the second task is optimized using the parameter. As a result, it is possible to reduce the arithmetic amount of the image recognition processing while achieving the image recognition processing with high accuracy, and it is possible to reduce power consumption and suppress a processing delay. As a result, it is possible to present appropriate and real-time driving assistance information based on a highly accurate image recognition processing result, while reducing the arithmetic amount of the peripheral sensing system of the vehicle.

### 1.4. Third Embodiment

In the third embodiment, an example will be described in which the technology described in the first embodiment is applied to image recognition processing on each image acquired by each of a plurality of imaging units mounted on a vehicle, and an image recognition processing result is used for automated driving. The second embodiment and the third embodiment are mainly different in an application destination of the image recognition processing result, and other configurations are substantially similar. Hereinafter, different points will be mainly described.

### [Information Processing System]

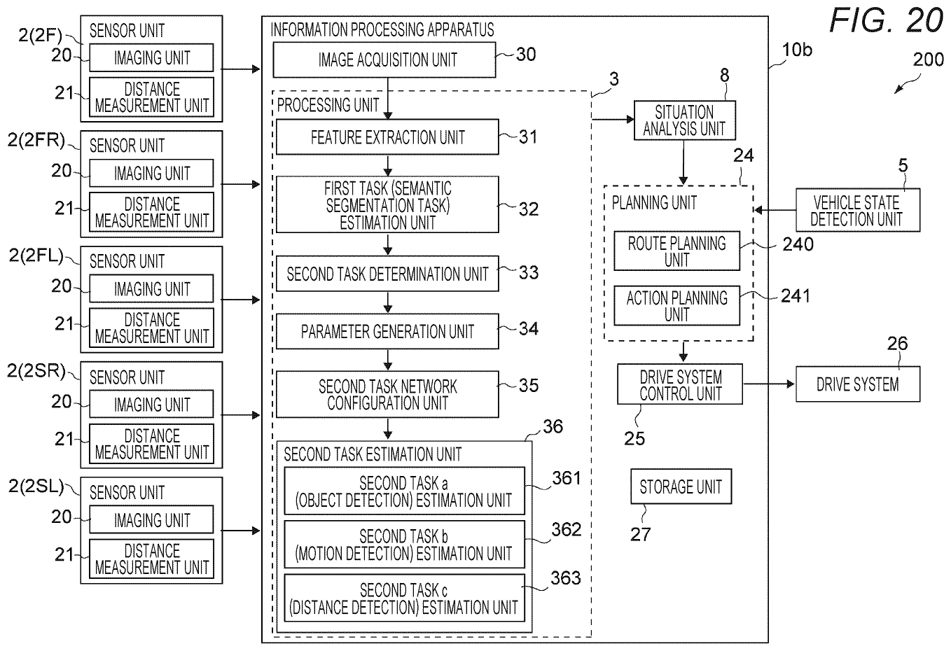

FIG. 20 is a schematic configuration diagram of an information processing system 200 according to the present embodiment. In the information processing system 200, automated driving processing using recognition processing results of acquired images of a plurality of imaging units mounted on the vehicle 1 described above is performed. The information processing system of the present embodiment can be rephrased as an automated driving system.

As illustrated in FIG. 20, the information processing system 200 includes a plurality of sensor units 2, the information processing apparatus 10b, a vehicle state detection unit 5, and a drive system 26. These are all mounted on the vehicle 1.

### (Sensor Unit)

Each sensor unit 2 includes an imaging unit 20 and a distance measurement unit 21.

The imaging unit 20 acquires an image. As the imaging unit 20, a monocular camera, a stereo camera, or the like can be used.

The distance measurement unit 21 is configured to be able to measure a distance between the vehicle 1 and an object around the vehicle 1. For the distance measurement unit 21, LiDAR, a stereo camera, a millimeter wave radar, or the like can be used, and the distance measurement unit 21 includes one or more selected from these. In the present embodiment, an example in which LiDAR is used as the distance measurement unit 21 will be described.

An image acquired by the imaging unit 20 of the sensor unit 2 and three-dimensional point group information acquired by LiDAR as the distance measurement unit 21 are output to the information processing apparatus 10b.

### (Vehicle State Detection Unit)

The vehicle state detection unit 5 detects a state of the vehicle. The vehicle state detection unit 5 includes, for example, a gyro sensor, an acceleration sensor, an inertial measurement unit (IMU), and a sensor for detecting an operation amount of an accelerator pedal, an operation amount of a brake pedal, a steering angle of a steering wheel, an engine speed, a motor speed, a rotation speed of the vehicle, or the like. Information such as a speed and a steering angle of the vehicle 1 detected by the vehicle state detection unit 5 is output to a planning unit 24 described later.

### (Drive System)

The drive system 26 includes various devices related to a driving system of the vehicle (own vehicle) 1. For example, the drive system includes: a driving force generation device for generation of a driving force such as an internal combustion engine or a driving motor, a driving force transmission mechanism for transmission of a driving force to wheels, a steering mechanism to adjust a steering angle, a braking device to generate a braking force, an antilock brake system (ABS), an electronic stability control (ESC), an electric power steering device, and the like.

The drive system 26 is controlled on the basis of various control signals supplied from a drive system control unit 25 described later.

### (Information Processing Apparatus)

The information processing apparatus 10b has a hardware configuration necessary for a computer, such as, for example, a CPU, a memory (RAM, ROM), and the like. The CPU loads a program stored in a storage unit 27 described later into the RAM and executes the program, thereby executing various types of processing including the image recognition processing according to the present technology.

In the information processing apparatus 10b, semantic segmentation (first task) is performed for each input image from the imaging unit 20 of each of the plurality of sensor units 2. Then, using a semantic segmentation result, a task (second task) to be used for the image recognition processing is determined, and a parameter for the task is generated.

The information processing apparatus 10b includes a processing unit 3, an image acquisition unit 30, a situation analysis unit 8, the planning unit 24, the drive system control unit 25, and the storage unit 27.

### ((Image Acquisition Unit))

The image acquisition unit 30 acquires an image acquired by the imaging unit 20 of each sensor unit 2. The image is output to the processing unit 3.

### ((Processing Unit))

The processing unit 3 performs recognition processing on the image (input image) acquired by the image acquisition unit 30. At this time, as described in the first and second embodiments, the processing unit 3 uses a result of execution of the first task performed on the input image, to determine whether or not to execute the second task and generate parameters for the second task.

### ((Situation Analysis Unit))

The situation analysis unit 8 performs analysis processing on a peripheral situation of the vehicle on the basis of a recognition processing result (semantic segmentation result) of the first task and a recognition processing result (one or more processing results selected from an object detection result, a motion detection result, and a distance detection result) of the second task. An analysis result is output to the planning unit 24.

### ((Planning Unit))

The planning unit 24 plans a route and an action of the vehicle 1 for safely traveling a route to a destination within time. The planning unit 24 plans a route and an action to perform collision avoidance or impact mitigation of the own vehicle, follow-up traveling based on an inter-vehicle distance, vehicle speed maintaining traveling, and the like at the time of vehicle traveling by automated driving.

The planning unit 24 includes a route planning unit 240 and an action planning unit 241.

The route planning unit 240 plans a route to a destination by using map information, state information of the vehicle 1 detected by the vehicle state detection unit 5, and the like. Furthermore, the route planning unit 240 appropriately changes the route by using an analysis result of the situation analysis unit 8. The route planning unit 240 outputs data indicating the planned route to the action planning unit 241.

The action planning unit 241 plans an action of the vehicle 1 for safely traveling the route planned by the route planning unit 240 within planned time. For example, the action planning unit 241 plans start, stop, a traveling direction (for example, forward, backward, left turn, right turn, direction change, and the like), a traveling lane, a traveling speed, overtaking, and the like. The action planning unit 241 supplies data indicating the planned action of the vehicle 1 to the drive system control unit 25. Furthermore, the action planning unit 241 appropriately changes the action plan by using the analysis result of the situation analysis unit 8.

For example, when it is recognized that only an immovable attention object is present in an input image, the object detection and the distance detection are performed in the recognition processing on the input image. Then, according to distance information between the attention object and the vehicle estimated by the distance detection, a steering angle and a brake can be automatically controlled so as not to collide with the attention object.

Whereas, when it is recognized that there is a movable attention object in the input image, the object detection, the motion detection, and the distance detection are performed in the recognition processing on the input image. Then, according to motion information and distance information of the attention object estimated by the respective detections, a steering angle and a brake can be automatically controlled so as not to collide with the attention object.

As described above, in the image recognition processing according to the present embodiment, in a case where there is only an immovable attention object, the motion detection is not performed. Therefore, the arithmetic amount of the image recognition processing can be reduced without deteriorating the recognition accuracy. Then, an automatic steering function and an automatic braking function can be achieved using an image recognition result.

An analysis result of a peripheral situation of the vehicle by the situation analysis unit 8 described above is generated using an image recognition processing result in the processing unit 3. The processing unit 3 of the information processing apparatus 10b of the present embodiment can perform image recognition processing without deteriorating image recognition accuracy. Therefore, an analysis result of a peripheral situation of the vehicle performed using the highly accurate image recognition processing result is highly accurate information. Then, the route planning and the action planning performed using the highly accurate information are more suitable for a situation surrounding the vehicle 1, and the safety of the automated driving is further improved.

Furthermore, in the processing unit 3 of the information processing apparatus 10b according to the present technology, since the arithmetic amount of the image recognition processing can be reduced, the processing delay is suppressed, and automated driving based on a more accurate route plan and action plan can be performed at a more accurate timing.

### ((Drive System Control Unit))

The drive system control unit 25 generates various control signals on the basis of data indicating an action of the vehicle 1 planned by the action planning unit 241, and supplies the control signals to the drive system 26.

### ((Storage Unit))

The storage unit 27 stores various programs and data necessary for processing in the information processing apparatus 10b. For example, the storage unit 27 stores a program for executing a series of processing related to the image recognition processing performed by the processing unit 3 of the present technology. For example, the storage unit 27 stores various parameters to be used in the processing related to the image recognition processing, and logs related to traveling and the like of the vehicle. For example, the storage unit 27 stores a program for executing a series of processing performed by each of the situation analysis unit 8, the planning unit 24, and the drive system control unit 25.

The storage unit 27 includes, for example, a ROM, a RAM, a magnetic storage device such as an HDD, a semiconductor storage device, an optical storage device, a magneto-optical storage device, and the like.

A series of information processing methods in the processing unit 3 is similar to that in the second embodiment.

Also in the present embodiment, similarly to the first and second embodiments, the arithmetic amount can be reduced by extracting the five feature amounts f1 to f5 that can be used in common in a plurality of tasks. Furthermore, since it is possible to determine the second task to be executed and generate parameters in accordance with a processing result of the first task, a neural network of the second task can be optimized. As a result, for example, the arithmetic amount on the decoder side can be reduced as compared with the processing in the standard neural network.

With such a configuration, it is possible to reduce the arithmetic amount related to the image recognition processing while achieving the image recognition processing with high accuracy. As a result, it is possible to reduce power consumption and suppress a processing delay, and it is possible to accurately perform automated driving (automated traveling) control performed in real time on the basis of the image recognition processing result.

### 1.5. Fourth Embodiment

Next, a fourth embodiment of the present disclosure will be described. As described in the first to third embodiments above, one of the features is that the information processing apparatus 10 determines whether or not to execute processing of the second task and the like on the basis of a result of semantic segmentation which is the first task.

In other words, the semantic segmentation is always performed. For this reason, in a scene with a heavy processing load of the semantic segmentation, for example, a complicated intersection, a situation is also assumed in which it is difficult to reduce a processing amount (arithmetic amount).

Therefore, the fourth embodiment of the present disclosure proposes an information processing apparatus 10c capable of reducing the processing amount of semantic segmentation.

In order to reduce the processing amount of the semantic segmentation, in the fourth embodiment of the present disclosure, an image acquired by LiDAR may be used as an input image.

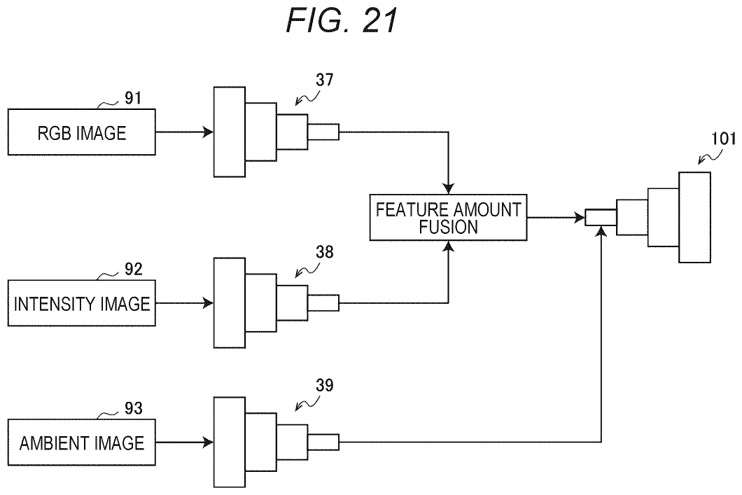

FIG. 21 is a diagram for describing an input image that is used in the fourth embodiment of the present disclosure.

As illustrated in FIG. 21, in addition to an RGB image 91, an intensity image 92 or an ambient image 93 acquired by LiDAR may be used as an input image according to the present embodiment.

Here, the intensity image 92 may be an image representing a peak value of an intensity of light received by each pixel included in the LiDAR in every unit time.

Whereas, the ambient image 93 may be an image representing an amount of light received by each pixel included in the LiDAR in predetermined time.

The image acquired by LiDAR such as the intensity image 92 and the ambient image 93 generally has a resolution smaller than that of the RGB image 91. Therefore, by using these images, an effect of reducing the processing amount required for the semantic segmentation is expected.

Note that, in a case of using the intensity image 92 as the input image, a 3D feature amount of the intensity image 92 extracted by a feature extractor 38 may be fused with a 3D feature amount of the RGB image 91 extracted by a feature extractor 37, and then input to a neural network 101 for semantic segmentation.

Whereas, in a case of using the ambient image 93 as the input image, a 2D feature amount of the ambient image 93 extracted by a feature extractor 39 is input to the neural network 101 for semantic segmentation without being aggregated with the 3D feature amount of the RGB image 91.

Each feature amount input to the neural network 101 is optimized by learning a sum of loss functions of four tasks of the semantic segmentation, object detection, motion detection, and distance detection, and minimizing the loss functions of all the tasks.

Furthermore, in order to reduce the processing amount of the semantic segmentation, in the fourth embodiment of the present disclosure, first semantic segmentation (hereinafter, referred to as first segmentation) using a first neural network model (hereinafter, also referred to as a first model) and second semantic segmentation (hereinafter, referred to as second segmentation) using a second neural network model (hereinafter, also referred to as a second model) are performed.

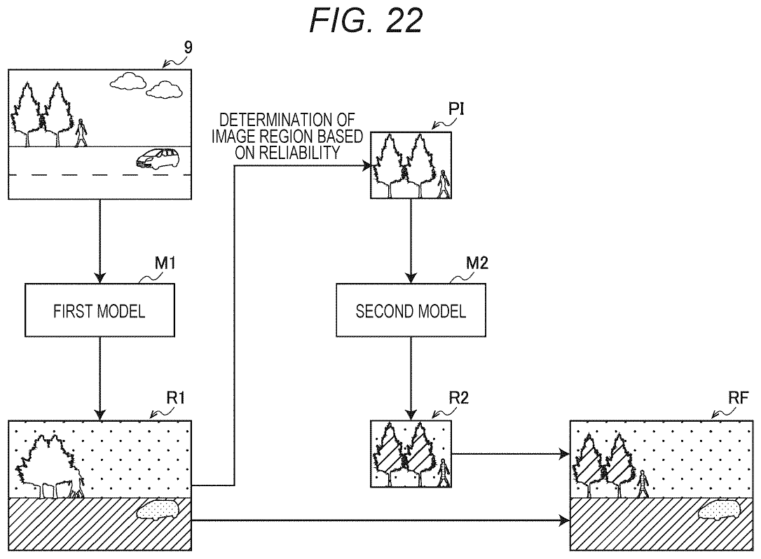

FIG. 22 is a diagram for describing the first segmentation and the second segmentation according to the present embodiment.

A first task estimation unit 32 included in the information processing apparatus 10c according to the present embodiment first performs the first segmentation on an input image 9 by using a first model M1, to divide, on a pixel basis, regions corresponding to N classes such as a road surface, a sidewalk, the sky, a pedestrian, a vehicle, a cyclist, a building, a wall, a curbstone, a plant, a guardrail, a utility pole, a sign, a traffic signal, an animal, a trash bin, and a pole.

In the first segmentation, the first task estimation unit 32 according to the present embodiment estimates a probability that each pixel is of each of the N classes defined in advance, and sets a class having the highest probability as an estimation result of the pixel.

Here, the first model M1 used in the first segmentation may be a model having a higher processing speed and a smaller memory consumption amount than those of a second model M2 described later.

According to the first model M1, it is possible to perform segmentation with a high reliability on classes of the sky, a building, a road surface, and a pedestrian, a bicycle, a car, and the like at a short distance, which are easily segmented.

Whereas, in the first model M1, a reliability of segmentation for classes such as a pedestrian, a bicycle, a car, or a tree at a long distance may be low.

Therefore, one of the features of the first task estimation unit 32 according to the present embodiment is to perform the second segmentation using the second model M2 on an image region PI in which a reliability related to a result R1 of the first segmentation using the first model M1 is lower than a threshold value.

Here, the second model M2 used in the second segmentation may be a neural network model capable of performing semantic segmentation with higher estimation accuracy than the first model.

Furthermore, the first task estimation unit 32 according to the present embodiment outputs a first task estimation result on the basis of the result R1 of the first segmentation and a result R2 of the second segmentation.

More specifically, the first task estimation unit 32 according to the present embodiment may output, as the first task estimation result, an aggregated segmentation result RF obtained by aggregating the result R1 of the first segmentation and the result R2 of the second segmentation.

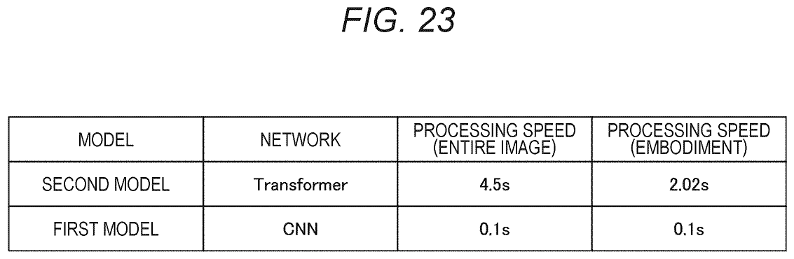

FIG. 23 is a table for describing a performance example of the first model M1 and the second model M2 according to the present embodiment.

The first model M1 according to the present embodiment may be, for example, a convolutional neural network (CNN).

In this case, it takes about 0.1 s to perform the semantic segmentation on the entire input image using the first model M1.

Whereas, the second model M2 according to the present embodiment may be, for example, Transformer, which is excellent in global information processing.

In this case, it takes about 4.5 s to perform the semantic segmentation on the entire input image using the second model M2.

Here, it is assumed that the first segmentation using the first model M1 is performed on the entire input image, and image regions whose reliability is lower than a threshold value (for example, 95%) are nine regions out of 20 divisions of the input image.

Here, in a case where the second segmentation using the second model M2 is performed on the nine regions described above, a total processing speed is 0.1 s+4.5 s*9/20=2.125 s, which is about 2.1 times faster than that of a case where the segmentation is performed on the entire input image using the second model M2.

As described above, according to the first task estimation unit 32 according to the present embodiment, it is possible to improve the processing speed and further reduce the memory consumption amount while ensuring the accuracy of semantic segmentation.

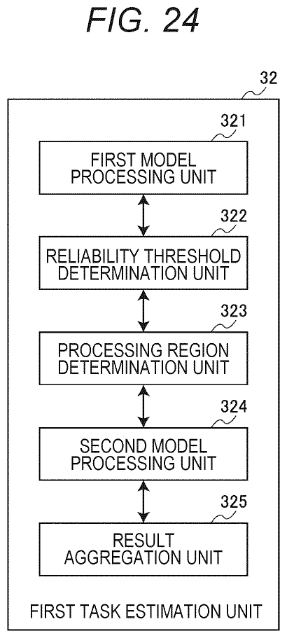

Hereinafter, with reference to FIG. 24, a functional configuration example of the first task estimation unit 32 according to the present embodiment will be described.

As illustrated in FIG. 24, the first task estimation unit 32 according to the present embodiment may include a first model processing unit 321, a reliability threshold determination unit 322, a processing region determination unit 323, a second model processing unit 324, and a result aggregation unit 325.

The first model processing unit 321 according to the present embodiment performs the first segmentation using the first model M1.

The first model processing unit 321 according to the present embodiment outputs a result of the first segmentation and a reliability map related to the result of the first segmentation.

The reliability threshold determination unit 322 according to the present embodiment determines a threshold value of a reliability related to the result of the first segmentation. The threshold value is used to determine an image region to be subjected to the second segmentation.

The reliability threshold determination unit 322 according to the present embodiment may determine the threshold value of the reliability related to the result of the first segmentation on the basis of, for example, a budget of a processing amount (for example, including an arithmetic amount, a memory consumption amount, a memory capacity, and the like).

Accordingly, it is possible to more reliably reduce the processing amount and improve the processing speed.

Whereas, the reliability threshold determination unit 322 according to the present embodiment may determine the threshold value of the reliability related to the result of the first segmentation on the basis of, for example, required estimation accuracy of an important class related to the first segmentation.

Accordingly, it is expected to reduce the processing amount and improve the processing speed while ensuring the estimation accuracy for the important class.

The processing region determination unit 323 according to the present embodiment determines an image region to be subjected to the second segmentation on the basis of the threshold value determined by the reliability threshold determination unit 322.

More specifically, the processing region determination unit 323 according to the present embodiment determines the image region to be subjected to the second segmentation in a region in which the reliability related to the result of the first segmentation is lower than the threshold value described above.

The second model processing unit 324 according to the present embodiment performs the second segmentation using the second model M2, and outputs a result of the second segmentation.

The result aggregation unit 325 according to the present embodiment outputs an aggregated segmentation result obtained by aggregating the result of the first segmentation and the result of the second segmentation.

The functional configuration example of the first task estimation unit 32 according to the present embodiment has been described above. Note that the functional configuration described above with reference to FIG. 24 is merely an example, and the functional configuration of the first task estimation unit 32 according to the present embodiment is not limited to such an example.

For example, the first task estimation unit 32 according to the present embodiment may further include an image processing unit that performs various types of processing on an input image. However, the image processing unit as described above is not necessarily provided in the first task estimation unit 32, and may be provided as a configuration separate from the first task estimation unit 32.

Next, a flow of processing by the first task estimation unit 32 according to the present embodiment will be described with an example.

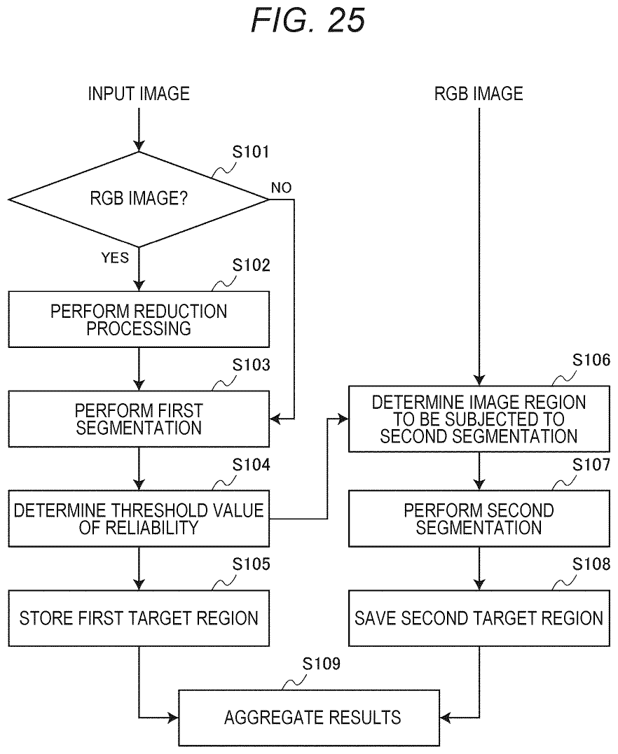

FIG. 25 is a flowchart illustrating a flow of processing in a case where at least an RGB image is used as an input image.

In the case of the example illustrated in FIG. 25, first, it is determined whether or not the input image is an RGB image (S101).

Here, in a case where it is determined that the input image is an RGB image (S101: YES), reduction processing for reducing a resolution of the image is performed (S102).

By performing the reduction processing as described above, a processing amount of the first segmentation can be reduced.

However, in a case where the input image is an ambient image or an intensity image, the reduction processing in step S102 may be skipped since the original resolution is small.

Next, the first model processing unit 321 performs the first segmentation using the first model M1 on the image (resolution H×W×3: H is the number of vertical pixels of the image, and W is the number of pixels of the width of the image) (S103).

Specifically, the first model M1 outputs logits (C×H×W: C is the number of classes to be subjected to segmentation) of every pixel, and a variance (log\hat{ }(σ\hat{ }2)) (1×H×W) of the logits.

As shown in the following Expression (1), the first model M1 performs processing of adding Gaussian noise whose standard deviation is √(e\hat{ }σ) to the output logits T times to obtain T pieces of logits.

Next, the first model M1 multiplies the T pieces of logits by softmax as shown in the following Expression (2). A final probability value P (C×H×W) may be an average value of the T times.

Next, the first model M1 calculates entropy of the probability value P for each class as shown in the following Expression (3), and takes an average of the classes to obtain a reliability map of the first segmentation.

Note that, since a value of the reliability is 1-entropy, a lower numerical value indicates that the segmentation result is more reliable, and a lower reliability indicates that uncertainty of the segmentation result is higher.

Furthermore, the first model M1 estimates a class of every pixel using the following Expression (4), and outputs a result of the first segmentation.

$$[ Math . 1 ]$$

$${logits}^{T} = logits + N ( 0 , sqrt ( exp ( σ ) ) ) \qquad ( 1 )$$

$$P = \frac{1}{T} {\sum }_{i = 1}^{T} softmax ( {logits}^{T} ) \qquad ( 2 )$$

$$H ( P ) = 1 - {\sum }_{c = 1}^{C} {P}_{c} {log}^{{P}_{c}} \qquad ( 3 )$$

$$P 1 = {max}_{c = 1}^{C} ( P ) \qquad ( 4 )$$

Next, the reliability threshold determination unit 322 according to the present embodiment determines a reliability threshold value according to the first segmentation (S104).

As described above, the reliability threshold determination unit 322 may determine the threshold value on the basis of a budget of a processing amount, required estimation accuracy of an important class related to the first segmentation, and the like.

In a case where the threshold value is set to be high, the image region to be subjected to the second segmentation is large. Whereas, in a case where the threshold value is set to be low, the image region to be subjected to the second segmentation is small.

Next, the processing region determination unit 323 according to the present embodiment stores a target region (first target region) to be aggregated with a result of the second segmentation among results of the first segmentation, on the basis of the result of the first segmentation and the reliability map output in step S103 and the threshold value determined in step S104 (S105).

A first target region A1 is defined by the following Expression (5). Furthermore, the mask in Expression (5) is defined by the following Expression (6).

However, in a case where the RGB image reduction processing is performed in step S102, up-sampling is performed in order to set the result of the first segmentation to the original resolution. The up-sampling may be performed by using a nearest neighbor method as shown in the following Expression (7).

$$[ Math . 2 ]$$

$$A 1 = P 1 \times mask \qquad ( 5 )$$

$$mask = H ( P ) \geq T \qquad ( 6 )$$

$$A 1 = Resize ( P 1 \times mask , NEAREST ) \qquad ( 7 )$$

Subsequently, the processing region determination unit 323 according to the present embodiment determines the image region to be subjected to the second segmentation, on the basis of the result of the first segmentation and the reliability map output in step S103 and the threshold value determined in step S104 (S106).

Specifically, the processing region determination unit 323 filters the RGB image (input image) by the following Expression (8), obtains a non-zero image region, and sets the image region as the image region to be subjected to the second segmentation.

$$Image region to be subjected to second segmentation = input image [ 1 - mask ] \qquad ( 8 )$$

The image region to be subjected to the second segmentation is a region that does not require processing by the image processing unit and has a low reliability in the original input image. Therefore, it is possible to perform segmentation with high accuracy on a small object such as a pedestrian, a car, a bicycle, a wheel stopper, or a lock plate in a distant place.

Next, the second model processing unit 324 performs the second segmentation using the second model M2 on the image region obtained by the above-described Expression (8) (S107).

The second model processing unit 324 outputs a segmentation result logits, and estimates a class of every pixel by the following Expression (9). An estimation result is stored as a second target region (S108).

$$[ Math . 3 ]$$

$$P 2 = {max}_{c = 1}^{C} softmax ( logits ) \qquad ( 9 )$$

Next, the result aggregation unit 325 aggregates the first target region that is the result of the first segmentation and the second target region that is the result of the second segmentation (S109). The aggregation may be performed by using the following Expression (10).

$$[ Math . 4 ]$$

$$P = P 1 \times mask + P 2 \times ( 1 - mask ) \qquad ( 10 )$$

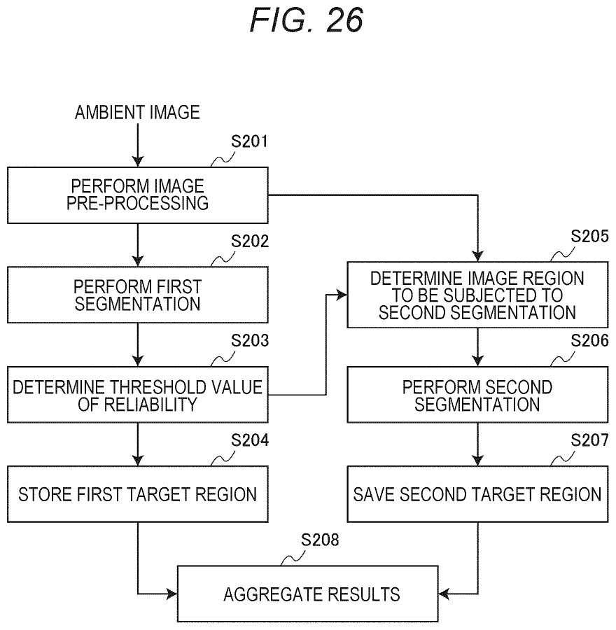

Next, a flow of processing in a case where only an ambient image is used as an input image will be described with reference to FIG. 26.

The ambient image generally has a lower resolution than the RGB image. Therefore, in a case where only an ambient image is used as the input image, the image reduction processing does not need to be performed, unlike the example illustrated in FIG. 25.

Whereas, in a case where the input image is an ambient image, image pre-processing such as contrast adjustment may be performed as illustrated in step S201 of FIG. 26.

Processing in other steps illustrated in FIG. 26 may be equivalent to the processing described with reference to FIG. 25, and thus a detailed description thereof is omitted.

The ambient image is more resistant to weather (rain, fog, and the like) and a time zone (night) than that of the RGB image, and has an advantage that a processing amount required for performing the second segmentation is small.

Whereas, an RGB image is easily affected by noise depending on weather (rain, fog, and the like) or a time zone (night), but is good at recognition of a plant, a signal, a white line, a yellow line, a cone, and the like since color information is captured.

Therefore, a situation is also assumed in which the estimation accuracy is improved by using both the RGB image and the ambient image as the input image.

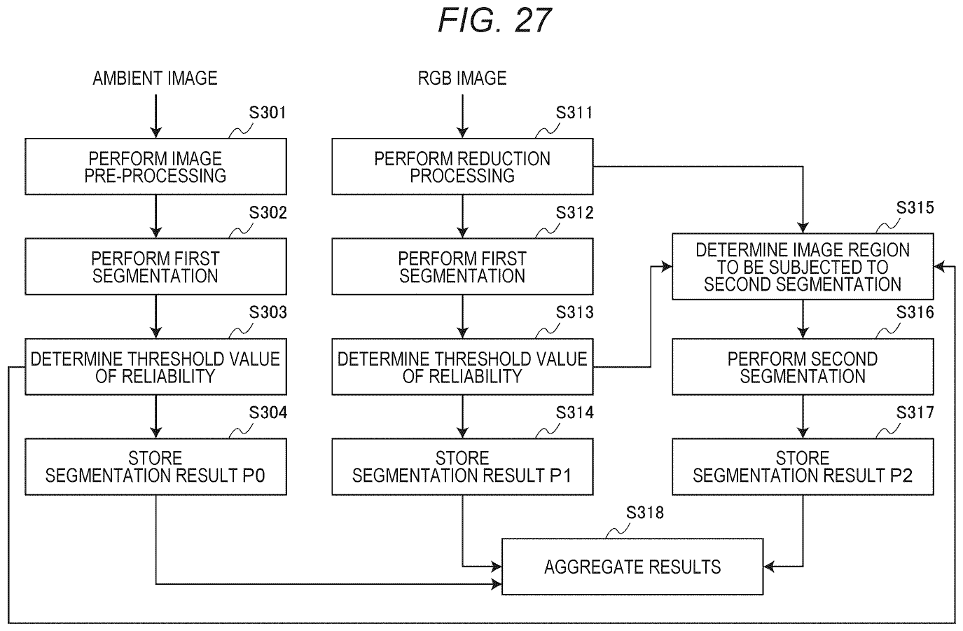

FIG. 27 is a flowchart illustrating a flow of processing in a case where both the RGB image and the ambient image are used as input images.

In the case of the example illustrated in FIG. 27, first, pre-processing such as contrast adjustment is performed on the ambient image (S301).

Next, the first segmentation using the first model M1 is performed on the ambient image subjected to the pre-processing, and a reliability map and a result of the first segmentation are obtained by the above-described Expressions (3) and (4), respectively (S302).

Next, a threshold value is determined on the basis of the reliability map (S303).

Next, masking processing is performed on the reliability map on the basis of the determined threshold value, and a segmentation result P0 of the mask region is stored (S304).

Whereas, on the RGB image, reduction processing is performed first (S311).

Next, the first segmentation using the first model M1 is performed on the RGB image subjected to the reduction processing, and a reliability map and a result of the first segmentation are obtained by the above-described Expressions (3) and (4), respectively (S312).

Next, a threshold value is determined on the basis of the reliability map (S313).

Next, masking processing is performed on the reliability map on the basis of the threshold value determined using the above-described Expression (7), and a segmentation result P1 of a mask region resized so as to return to the original resolution is stored (S314).

Furthermore, the image region to be subjected to the second segmentation is determined by Expression (11) (S315).

$$Image region to be subjected to second segmentation = input image [ 1 - ( H ( P 0 ) \geq T ) - ( H ( P 1 ) \geq T ) ] \qquad ( 11 )$$

Next, the second segmentation using the second model M2 is performed on the determined image region, and output of a segmentation result logits and class estimation are performed on every pixel by the above-described Expression (9) (S316).

A segmentation result P2 is saved (S317).

Next, as shown in the following Expression (12), the segmentation result P0, the segmentation result P1, and the segmentation result P2 are aggregated to generate a final segmentation result P.

$$[ Math . 5 ]$$

$$P = P 0 \times ( H ( P 0 ) \geq T ) + P 1 \times ( H ( P 1 ) \geq T ) + P 2 \times ( 1 - H ( P 1 ) \geq T - H ( P 0 ) \geq T ) \qquad ( 12 )$$

The processing of the first task estimation unit 32 according to the fourth embodiment has been described in detail above. According to the processing as described above, it is possible to improve the processing speed and further reduce the memory consumption amount while ensuring the accuracy of semantic segmentation.

Note that, as described in the first to third embodiments, a result of the semantic segmentation, which is the first task, is used to determine whether or not to execute processing of the second task, and the like.

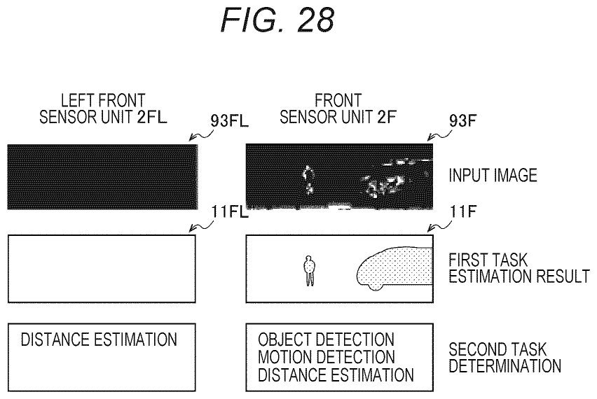

FIG. 28 is a diagram for describing a determination example of whether or not to execute processing of the second task in a case where the above-described semantic segmentation is performed on an ambient image.

FIG. 28 exemplifies a case where an ambient image 93FL and an ambient image 93F are acquired by the left front sensor unit 2FL and the front sensor unit 2F, respectively.

The first task estimation (semantic segmentation) is individually performed on the ambient image 93FL and the ambient image 93F, and a first task estimation result 11FL and a first task estimation result 11F are acquired.

Here, in a case where there is no movable object in the first task estimation result as in 11FL, an automatic steering and an automatic braking function can be implemented by estimating distances of a stationary wall, curbstone, and pole by only performing the distance detection.

Whereas, in a case where objects such as a pedestrian and a car are present as in the first task estimation result 11F, it is necessary to obtain motion information and distance information of each object, and three recognition tasks of the object detection, the object motion detection, and the distance estimation are to be executed.

Furthermore, for the object detection and the motion detection, it is possible to know an image region where objects such as a pedestrian and a car are present and vertical and horizontal widths thereof. Therefore, it is also possible to control an execution range of the object detection and the motion detection, and parameters inside detection. Accordingly, the entire peripheral sensing can be achieved with a smaller processing amount.

### 2. HARDWARE CONFIGURATION EXAMPLE

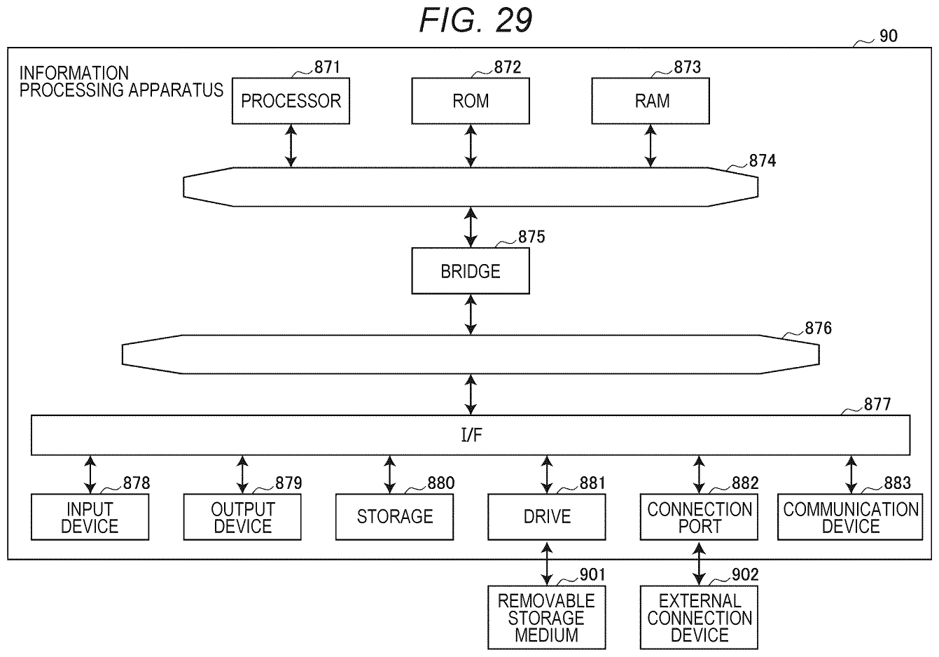

Next, a hardware configuration example of an information processing apparatus 90 according to an embodiment of the present disclosure will be described. FIG. 29 is a block diagram illustrating a hardware configuration example of the information processing apparatus 90 according to an embodiment of the present disclosure. The information processing apparatus 90 may be an apparatus having a hardware configuration equivalent to that of the information processing apparatus 10 described in the first to fourth embodiments.

As illustrated in FIG. 29, the information processing apparatus 90 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. Note that the hardware configuration illustrated here is an example, and some of the configuration elements may be omitted. Furthermore, configuration elements other than the configuration elements illustrated here may be further included.

### (Processor 871)

The processor 871 functions as, for example, an arithmetic processing device or a control device, and controls an overall operation of each configuration element or a part thereof on the basis of various programs recorded in the ROM 872, the RAM 873, the storage 880, or a removable storage medium 901.

### (ROM 872 and RAM 873)

The ROM 872 is a means for storing a program to be read into the processor 871, data to be used for calculation, and the like. The RAM 873 temporarily or permanently stores, for example, a program to be read into the processor 871, various parameters that appropriately change when the program is executed, and the like.

### (Host Bus 874, Bridge 875, External Bus 876, and Interface 877)

The processor 871, the ROM 872, and the RAM 873 are mutually connected via, for example, the host bus 874 capable of high-speed data transmission. Meanwhile, the host bus 874 is connected to the external bus 876 having a relatively low data transmission speed via the bridge 875, for example. Furthermore, the external bus 876 is connected to various configuration elements via the interface 877.

### (Input Device 878)

As the input device 878, for example, a mouse, a keyboard, a touch panel, a button, a switch, a lever, or the like is used. Moreover, as the input device 878, a remote controller (hereinafter referred to as a remote control) capable of transmitting a control signal using infrared rays or other radio waves may be used. Furthermore, the input device 878 includes a voice input device such as a microphone.

### (Output Device 879)

The output device 879 is, for example, a device capable of visually or auditorily notifying the user of obtained information, such as a display device such as a cathode ray tube (CRT), a liquid crystal display (LCD), an organic electroluminescence (EL), or the like, an audio output device such as a speaker, a headphone, or the like, a printer, a mobile phone, a facsimile, or the like. Furthermore, the output device 879 according to the present disclosure includes various vibration devices capable of outputting a haptic stimulus.

### (Storage 880)

The storage 880 is a device for storing various types of data. As the storage 880, for example, a magnetic storage device such as a hard disk drive (HDD) or the like, a semiconductor storage device, an optical storage device, a magneto-optical storage device, or the like is used.

### (Drive 881)

The drive 881 is, for example, a device that reads information recorded in the removable storage medium 901 such as a magnetic disk, an optical disk, a magneto-optical disk, a semiconductor memory or the like, or writes information in the removable storage medium 901.

### (Removable Storage Medium 901)

The removable storage medium 901 is, for example, a digital versatile disc (DVD) medium, a Blu-ray (registered trademark) medium, an HD DVD medium, various semiconductor storage media, or the like. It is needless to say that the removable storage medium 901 may be, for example, an integrated circuit (IC) card on which a non-contact IC chip is mounted, an electronic device, or the like.

### (Connection Port 882)

The connection port 882 is, for example, a port for connecting an external connection device 902 such as a universal serial bus (USB) port, an IEEE 1394 port, a small computer system interface (SCSI), an RS-232C port, an optical audio terminal, or the like.

### (External Connection Device 902)

The external connection device 902 is, for example, a printer, a portable music player, a digital camera, a digital video camera, an IC recorder, or the like.

### (Communication Device 883)

The communication device 883 is a communication device for connecting to a network, and is, for example, a wired or wireless local region network (LAN), Bluetooth (registered trademark), a communication card for wireless USB (WUSB), a router for optical communication, a router for asymmetric digital subscriber line (ADSL), a modem for various types of communication, or the like.

### 3. CONCLUSION

As described above, the information processing apparatus 10c according to the fourth embodiment of the present disclosure includes: the first model processing unit 321 configured to perform first segmentation on an input image, and output a result of the first segmentation and a reliability related to the result of the first segmentation; the second model processing unit 324 configured to perform second segmentation having higher accuracy than accuracy of the first segmentation on an image region in which a reliability related to a result of the first segmentation is lower than a threshold value, and output a result of the second segmentation; and the result aggregation unit 325 configured to output an estimation result based on a result of the first segmentation and a result of the second segmentation. Furthermore, the input image described above includes an image acquired by LiDAR.

According to the configuration as described above, it is possible to improve the processing speed and further reduce the memory consumption amount while ensuring the accuracy of semantic segmentation.

While the preferred embodiments of the present disclosure have been described in detail with reference to the accompanying drawings, the technical scope of the present disclosure is not limited to such examples. It is obvious that those with ordinary skill in the technical field of the present disclosure can conceive various alterations or corrections within the scope of the technical idea recited in the claims, and it is naturally understood that those alterations or corrections also fall within the technical scope of the present disclosure.

Furthermore, each step relating to a process described in the present disclosure is not necessarily processed in time series in the order described in a flowchart or a sequence diagram. For example, individual steps related to the processes of individual devices may be processed in an order different from the described order, or may be processed in parallel.

Furthermore, a series of processing performed by each device described in the present disclosure may be implemented by a program stored in a non-transitory computer readable storage medium. For example, each program is read into the RAM when the computer executes the program, and is executed by a processor such as a CPU. The storage medium described above is, for example, a magnetic disk, an optical disc, a magneto-optical disk, a flash memory, or the like. Furthermore, the program described above may be distributed via, for example, a network without using a storage medium.

Furthermore, the effects described in the present specification are merely exemplary or illustrative, and are not restrictive. In other words, the technique according to the present disclosure can produce other effects that are apparent to those skilled in the art from the description of the present description, in combination with or instead of the effects described above.

Note that, the following configurations also fall within the technological scope of the present disclosure.

(1)

An information processing apparatus including:
a first processing unit configured to perform first segmentation on an input image, and output a result of the first segmentation and a reliability related to the result of the first segmentation;
a second processing unit configured to perform second segmentation having higher accuracy than accuracy of the first segmentation on an image region in which a reliability related to a result of the first segmentation is lower than a threshold value, the second processing unit being configured to output a result of the second segmentation; and
an estimation unit configured to output an estimation result based on a result of the first segmentation and a result of the second segmentation, in which
the input image includes an image acquired by LiDAR.
   (2)

The information processing apparatus according to (1) above, in which
the estimation unit outputs, as the estimation result, an aggregated segmentation result obtained by aggregating a result of the first segmentation and a result of the second segmentation.
   (3)

The information processing apparatus according to (1) or (2) above, in which
the input image includes an ambient image representing an amount of light received by each pixel included in the LiDAR in predetermined time.
   (4)

The information processing apparatus according to any one of (1) to (3) above, in which
the first processing unit performs the first segmentation using a first neural network model,
the second processing unit performs the second segmentation using a second neural network model, and
the first neural network model has a higher processing speed than a processing speed of the second neural network.
   (5)

The information processing apparatus according to any one of (4) above, in which
the first neural network model has a memory consumption amount smaller than a memory consumption amount of the second neural network model.
   (6)

The information processing apparatus according to any one of (1) to (5) above, further including:
a reliability threshold determination unit configured to determine a threshold value of a reliability related to a result of the first segmentation.
   (7)

The information processing apparatus according to (6) above, in which
the reliability threshold determination unit determines a threshold value of a reliability related to a result of the first segmentation on the basis of a budget of a processing amount.
   (8)

The information processing apparatus according to (6) above, in which
the reliability threshold determination unit determines a threshold value of a reliability related to a result of the first segmentation on the basis of an important class related to the first segmentation.
   (9)

The information processing apparatus according to any one of (1) to (8) above, further including:
a processing unit configured to determine whether or not to execute processing of a second task on the basis of an estimation result based on a result of the first segmentation and a result of the second segmentation.
   (10)

The information processing apparatus according to (9) above, in which
the processing unit determines whether or not to execute processing of each of a plurality of the second tasks on the basis of an estimation result based on a result of the first segmentation and a result of the second segmentation.
   (11)

The information processing apparatus according to (10) above, in which
a feature amount extracted from the input image is used in common in a plurality of the second tasks.
   (12)

The information processing apparatus according to any one of (9) to (11) above, in which
the first segmentation and the second segmentation are semantic segmentation.
   (13)

The information processing apparatus according to any one of (9) to (12) above, in which
the second task includes at least one of object detection, motion detection, or distance detection.
   (14)

The information processing apparatus according to any one of (9) to (13) above, in which
the processing unit generates a parameter to be used in the second task, on the basis of an estimation result based on a result of the first segmentation and a result of the second segmentation.
   (15)

An information processing method performed by a processor,
the information processing method including:
performing first segmentation on an input image, and outputting a result of the first segmentation and a reliability related to the result of the first segmentation;
performing second segmentation having higher accuracy than accuracy of the first segmentation on an image region in which a reliability related to a result of the first segmentation is lower than a threshold value, and outputting a result of the second segmentation; and
outputting an estimation result based on a result of the first segmentation and a result of the second segmentation, in which
the input image includes an image acquired by LiDAR.
   (16)

A program for causing a computer to function as
an information processing apparatus including:
a first processing unit configured to perform first segmentation on an input image, and output a result of the first segmentation and a reliability related to the result of the first segmentation;
a second processing unit configured to perform second segmentation having higher accuracy than accuracy of the first segmentation on an image region in which a reliability related to a result of the first segmentation is lower than a threshold value, the second processing unit being configured to output a result of the second segmentation; and
an estimation unit configured to output an estimation result based on a result of the first segmentation and a result of the second segmentation, in which
the input image includes an image acquired by LiDAR.

### REFERENCE SIGNS LIST

10c Information processing apparatus
32 First task estimation unit
321 First model processing unit
322 Reliability threshold determination unit
323 Processing region determination unit
324 Second model processing unit
325 Result aggregation unit
M1 First model
M2 Second model

1. An information processing apparatus comprising:
a first processing unit configured to perform first segmentation on an input image, and output a result of the first segmentation and a reliability related to the result of the first segmentation;
a second processing unit configured to perform second segmentation having higher accuracy than accuracy of the first segmentation on an image region in which a reliability related to a result of the first segmentation is lower than a threshold value, the second processing unit being configured to output a result of the second segmentation; and
an estimation unit configured to output an estimation result based on a result of the first segmentation and a result of the second segmentation, wherein
the input image includes an image acquired by light detection and ranging (LiDAR).

2. The information processing apparatus according to claim 1, wherein
the estimation unit outputs, as the estimation result, an aggregated segmentation result obtained by aggregating a result of the first segmentation and a result of the second segmentation.

3. The information processing apparatus according to claim 1, wherein
the input image includes an ambient image representing an amount of light received by each pixel included in the LiDAR in predetermined time.

4. The information processing apparatus according to claim 1, wherein
the first processing unit performs the first segmentation using a first neural network model,
the second processing unit performs the second segmentation using a second neural network model, and
the first neural network model has a higher processing speed than a processing speed of the second neural network.

5. The information processing apparatus according to claim 4, wherein
the first neural network model has a memory consumption amount smaller than a memory consumption amount of the second neural network model.

6. The information processing apparatus according to claim 1, further comprising:
a reliability threshold determination unit configured to determine a threshold value of a reliability related to a result of the first segmentation.

7. The information processing apparatus according to claim 6, wherein
the reliability threshold determination unit determines a threshold value of a reliability related to a result of the first segmentation on a basis of a budget of a processing amount.

8. The information processing apparatus according to claim 6, wherein
the reliability threshold determination unit determines a threshold value of a reliability related to a result of the first segmentation on a basis of an important class related to the first segmentation.

9. The information processing apparatus according to claim 1, further comprising:
a processing unit configured to determine whether or not to execute processing of a second task on a basis of an estimation result based on a result of the first segmentation and a result of the second segmentation.

10. The information processing apparatus according to claim 9, wherein
the processing unit determines whether or not to execute processing of each of a plurality of the second tasks on a basis of an estimation result based on a result of the first segmentation and a result of the second segmentation.

11. The information processing apparatus according to claim 10, wherein
a feature amount extracted from the input image is used in common in a plurality of the second tasks.

12. The information processing apparatus according to claim 9, wherein
the first segmentation and the second segmentation are semantic segmentation.

13. The information processing apparatus according to claim 9, wherein
the second task includes at least one of object detection, motion detection, or distance detection.

14. The information processing apparatus according to claim 9, wherein
the processing unit generates a parameter to be used in the second task, on a basis of an estimation result based on a result of the first segmentation and a result of the second segmentation.

15. An information processing method performed by a processor,
the information processing method comprising:
performing first segmentation on an input image, and outputting a result of the first segmentation and a reliability related to the result of the first segmentation;
performing second segmentation having higher accuracy than accuracy of the first segmentation on an image region in which a reliability related to a result of the first segmentation is lower than a threshold value, and outputting a result of the second segmentation; and
outputting an estimation result based on a result of the first segmentation and a result of the second segmentation, wherein
the input image includes an image acquired by light detection and ranging (LiDAR).

16. A program for causing a computer to function as
an information processing apparatus comprising:
a first processing unit configured to perform first segmentation on an input image, and output a result of the first segmentation and a reliability related to the result of the first segmentation;
a second processing unit configured to perform second segmentation having higher accuracy than accuracy of the first segmentation on an image region in which a reliability related to a result of the first segmentation is lower than a threshold value, the second processing unit being configured to output a result of the second segmentation; and
an estimation unit configured to output an estimation result based on a result of the first segmentation and a result of the second segmentation, wherein
the input image includes an image acquired by light detection and ranging (LiDAR).
